(19) United States
(12) Patent Application Publication
(10) Pub. No.: US 2024/0267844 A1
(43) Pub. Date: Aug. 8, 2024

(54) FURTHER CONSIDERATIONS ON CELL WAKE-UP SIGNALS

(71) Applicant: QUALCOMM Incorporated, San Diego, CA (US)

(72) Inventors: Hung Dinh Ly, San Diego, CA (US); Wanshi Chen, San Diego, CA (US); Yongjun Kwak, San Diego, CA (US)

(21) Appl. No.: 18/165,856

(22) Filed: Feb. 7, 2023

(51) Int. Cl. H04W 52/02; H04L 1/08; H04L 5/00; H04W 74/08

(52) U.S. Cl. CPC H04W 52/0216; H04L 1/08; H04L 5/0048; H04W 74/0833

(57) ABSTRACT

Methods, systems, and devices for wireless communications are described. A user equipment (UE) may receive first signaling, and may transmit a first wake-up signal (WUS) based on information associated with a channel, where the information may be determined based on receiving the first signaling. The UE may monitor one or more channels, during a duration, for one or more signals based on transmitting the first WUS. If the UE fails to receive the one or more signals via the one or more channels during the duration, the UE may transmit a second WUS after the duration. The UE may communicate second signaling with a network entity based on transmitting the first WUS based on the information and successfully receiving the one or more signals, or based on transmitting the second WUS after the duration and successfully receiving one or more additional signals.

### FIELD OF TECHNOLOGY

The following relates to wireless communications, including further considerations on cell wake-up signals (C-WUSs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support further considerations, techniques, and operations for cell wake-up signals (C-WUSs). For example, a UE may receive, via a first receiver (e.g., a wake-up receiver), first signaling including one or more signals (e.g., synchronization signal or wake-up signal (WUS)). The UE may determine information associated with an uplink channel based on receiving the first signaling. Using the information, the UE may transmit signaling, such as a C-WUS, to a network entity requesting that the network entity transition to an active state for transmitting one or more downlink signals. For example, the UE may request that the network entity transmit one or more synchronization signal blocks (SSBs) or system information blocks (SIBs) after the network entity transitions to the active state. Based on receiving the C-WUS, the network entity may transmit the one or more signals via one or more channels, and the UE and the network entity 105 may communicate (e.g., transmit or receive or any combination of both) second signaling (e.g., random access signaling) based on the successful transmission of the C-WUS from the UE to the network entity and the downlink signaling from the network entity to the UE. In some examples, the UE may monitor to receive the signals during a duration, but may fail to receive the signals during the duration. Based on failing to receive the one or more signals during the duration, the UE may retransmit the C-WUS to the network entity using the same information used for transmitting the earlier C-WUS or new information (e.g., at least one aspect being different) different than the information used for transmitting the earlier C-WUS.

A method for wireless communication is described. The method may include receiving, via a first receiver, first signaling, transmitting a first wake-up signal based on information associated with a channel, where the information is determined based on receiving the first signaling, and communicating, via a second receiver, second signaling with a network entity based on transmitting the first wake-up signal.

An apparatus for wireless communication is described. The apparatus may include a processor, memory coupled with the processor, and instructions stored in the memory. The instructions may be executable by the processor to cause the apparatus to receive, via a first receiver, first signaling, transmit a first wake-up signal based on information associated with a channel, where the information is determined based on receiving the first signaling, and communicating, via a second receiver, second signaling with a network entity based on transmitting the first wake-up signal.

Another apparatus for wireless communication is described. The apparatus may include means for receiving, via a first receiver, first signaling, means for transmitting a first wake-up signal based on information associated with a channel, where the information is determined based on receiving the first signaling, and means for communicating, via a second receiver, second signaling with a network entity based on transmitting the first wake-up signal.

A non-transitory computer-readable medium storing code for wireless communication is described. The code may include instructions executable by a processor to receive, via a first receiver, first signaling, transmit a first wake-up signal based on information associated with a channel, where the information is determined based on receiving the first signaling, and communicating, via a second receiver, second signaling with a network entity based on transmitting the first wake-up signal.

Some examples of the method, apparatuses, and non-transitory computer-readable medium described herein may further include operations, features, means, or instructions for monitoring one or more channels, during a duration, for one or more signals based on transmitting the first wake-up signal, where communicating the second signaling with the network entity may be based on successfully receiving the one or more signals via the one or more channels during the duration.

Some examples of the method, apparatuses, and non-transitory computer-readable medium described herein may further include operations, features, means, or instructions for monitoring one or more channels, during a duration, for one or more signals based on transmitting the first wake-up signal and transmitting a second wake-up signal after the duration based on failing to receive the one or more signals via the one or more channels during the duration, where communicating the second signaling with the network entity may be based on transmitting the second wake-up signal after the duration.

In some examples of the method, apparatuses, and non-transitory computer-readable medium described herein, the duration may include a time window, where transmitting the second wake-up signal may be based on failing to receive the one or more signals within one or more symbols of the time window; or may include an expiration of a timer, where transmitting the second wake-up signal may be based on failing to receive the one or more signals before the expiration of the timer.

In some examples of the method, apparatuses, and non-transitory computer-readable medium described herein, the time window, the timer, or both, may be associated with a first subcarrier spacing, the first subcarrier spacing being associated with the first wake-up signal, the one or more signals, a predefined value, or any combination thereof.

In some examples of the method, apparatuses, and non-transitory computer-readable medium described herein, the second wake-up signal may be transmitted based on the information associated with the channel.

In some examples of the method, apparatuses, and non-transitory computer-readable medium described herein, the second wake-up signal may be transmitted based on second information different from the information.

In some examples of the method, apparatuses, and non-transitory computer-readable medium described herein, the one or more signals include at least a synchronization signal block, a signal including a system information block, or both, and the one or more channels include a physical broadcast channel, a physical downlink shared channel, or both.

In some examples of the method, apparatuses, and non-transitory computer-readable medium described herein, the second wake-up signal includes a retransmission of the first wake-up signal.

In some examples of the method, apparatuses, and non-transitory computer-readable medium described herein, communicating the second signaling with the network entity based on transmitting the first wake-up signal may include operations, features, means, or instructions for communicating, with the network entity, random access signaling as part of a random access procedure, where the random access signaling may be communicated based on the information associated with the channel.

In some examples of the method, apparatuses, and non-transitory computer-readable medium described herein, transmitting the first wake-up signal may include operations, features, means, or instructions for transmitting, within the first wake-up signal, channel configuration information associated with a downlink channel based on performing one or more measurements associated with the downlink channel, the one or more measurements performed based on receiving third signaling including downlink signaling, where the method further includes and receiving one or more reference signals based on transmitting the channel configuration information.

In some examples of the method, apparatuses, and non-transitory computer-readable medium described herein, transmitting the channel configuration information may include operations, features, means, or instructions for selecting a channel configuration based on performing the one or more measurements associated with the downlink channel and transmitting an indication of the selected channel configuration.

In some examples of the method, apparatuses, and non-transitory computer-readable medium described herein, the channel configuration information includes at least one of an antenna port configuration, an updated downlink power, or both and the downlink channel includes a physical downlink shared channel.

In some examples of the method, apparatuses, and non-transitory computer-readable medium described herein, the first wake-up signal including the channel configuration information may be based on one or more first coding sequences, one or more first preambles, one or more first resource occasions, or any combination thereof, associated with indicating the channel configuration information and different from one or more one or more second coding sequences, one or more second preambles, or one or more second resource occasions associated with a wake-up procedure.

In some examples of the method, apparatuses, and non-transitory computer-readable medium described herein, receiving the first signaling via the first receiver may include operations, features, means, or instructions for receiving the first signaling via the first receiver, where the first receiver may use a power below a second power associated with the second receiver.

In some examples of the method, apparatuses, and non-transitory computer-readable medium described herein, the information associated with the channel includes time resource information, frequency resource information, spatial resource information, path loss information, a transmit power, an uplink spatial filter, or any combination thereof, associated with the channel.

In some examples of the method, apparatuses, and non-transitory computer-readable medium described herein, the first signaling includes a wake-up signal, a synchronization signal, or both.

A method for wireless communication is described. The method may include transmitting first signaling, receiving a first wake-up signal based on information associated with a channel, where the information is based on the first signaling, and communicating second signaling with a user equipment based on receiving the first wake-up signal.

An apparatus for wireless communication is described. The apparatus may include a processor, memory coupled with the processor, and instructions stored in the memory. The instructions may be executable by the processor to cause the apparatus to transmit first signaling, receive a first wake-up signal based on information associated with a channel, where the information is based on the first signaling, and communicate second signaling with a user equipment based on receiving the first wake-up signal.

Another apparatus for wireless communication is described. The apparatus may include means for transmitting first signaling, means for receiving a first wake-up signal based on information associated with a channel, where the information is based on the first signaling, and means for communicating second signaling with a user equipment based on receiving the first wake-up signal.

A non-transitory computer-readable medium storing code for wireless communication is described. The code may include instructions executable by a processor to transmit first signaling, receive a first wake-up signal based on information associated with a channel, where the information is based on the first signaling, and communicate second signaling with a user equipment based on receiving the first wake-up signal.

Some examples of the method, apparatuses, and non-transitory computer-readable medium described herein may further include operations, features, means, or instructions for transmitting one or more signals via one or more channels during a duration, where communicating the second signaling with the user equipment may be based on transmitting the one or more signals.

Some examples of the method, apparatuses, and non-transitory computer-readable medium described herein may further include operations, features, means, or instructions for receiving a second wake-up signal after a duration and transmitting one or more signals via one or more channels based on receiving the second wake-up signal after the duration, where communicating the second signaling with the user equipment may be based on transmitting the one or more signals via the one or more channels.

In some examples of the method, apparatuses, and non-transitory computer-readable medium described herein, the duration includes a time window or an expiration of a timer and the one or more signals may be transmitted after one or more symbols of the time window or after the expiration of the timer.

In some examples of the method, apparatuses, and non-transitory computer-readable medium described herein, the time window, the timer, or both, may be associated with a first subcarrier spacing, the first subcarrier spacing being associated with the first wake-up signal, with the one or more signals, with a predefined value, or any combination thereof.

In some examples of the method, apparatuses, and non-transitory computer-readable medium described herein, the second wake-up signal may be received based on the information associated with the channel.

In some examples of the method, apparatuses, and non-transitory computer-readable medium described herein, the second wake-up signal may be received based on second information different from the information.

In some examples of the method, apparatuses, and non-transitory computer-readable medium described herein, the one or more signals include at least a synchronization signal block, a signal including a system information block, or both, and the one or more channels include a physical broadcast channel, a physical downlink shared channel, or both.

In some examples of the method, apparatuses, and non-transitory computer-readable medium described herein, the second wake-up signal includes a retransmission of the first wake-up signal.

In some examples of the method, apparatuses, and non-transitory computer-readable medium described herein, communicating the second signaling with the user equipment based on receiving the first wake-up signal may include operations, features, means, or instructions for communicating, with the user equipment, random access signaling as part of a random access procedure, where the random access signaling may be communicated based on the information associated with the channel.

In some examples of the method, apparatuses, and non-transitory computer-readable medium described herein, receiving the first wake-up signal may include operations, features, means, or instructions for receiving, within the first wake-up signal, channel configuration information associated with a downlink channel based on transmitting third signaling including downlink signaling, where the method further includes and transmitting one or more reference signals based on receiving the channel configuration information.

Some examples of the method, apparatuses, and non-transitory computer-readable medium described herein may further include operations, features, means, or instructions for receiving the channel configuration information includes receiving an indication of a selected channel configuration.

In some examples of the method, apparatuses, and non-transitory computer-readable medium described herein, the channel configuration information includes at least one of an antenna port configuration, a downlink power update, or both and the downlink channel includes a physical downlink shared channel.

In some examples of the method, apparatuses, and non-transitory computer-readable medium described herein, the first wake-up signal including the channel configuration information may be based on one or more first coding sequences, one or more first preambles, one or more first resource occasions, or any combination thereof, associated with indicating the channel configuration information and different from one or more one or more second coding sequences, one or more second preambles, or one or more second resource occasions associated with a wake-up procedure.

In some examples of the method, apparatuses, and non-transitory computer-readable medium described herein, the information associated with the channel includes time resource information, frequency resource information, spatial resource information, path loss information, a transmit power, an uplink spatial filter, or any combination thereof, associated with the channel.

In some examples of the method, apparatuses, and non-transitory computer-readable medium described herein, the first signaling includes a wake-up signal, a synchronization signal, or both.

### BRIEF DESCRIPTION OF THE DRAWINGS

FIG. 1 illustrates an example of a wireless communications system that supports further considerations on cell wake-up signals (C-WUSs) in accordance with one or more aspects of the present disclosure.

FIG. 2 illustrates an example of a signaling diagram that supports further considerations on C-WUSs in accordance with one or more aspects of the present disclosure.

FIGS. 3A and 3B illustrate examples of signaling diagrams that support further considerations on C-WUSs in accordance with one or more aspects of the present disclosure.

FIG. 4 illustrates an example of a process flow that supports further considerations on C-WUSs in accordance with one or more aspects of the present disclosure.

FIGS. 5 and 6 illustrate block diagrams of devices that support further considerations on C-WUSs in accordance with one or more aspects of the present disclosure.

FIG. 7 illustrates a block diagram of a communications manager that supports further considerations on C-WUSs in accordance with one or more aspects of the present disclosure.

FIG. 8 illustrates a diagram of a system including a device that supports further considerations on C-WUSs in accordance with one or more aspects of the present disclosure.

FIGS. 9 and 10 illustrate block diagrams of devices that support further considerations on C-WUSs in accordance with one or more aspects of the present disclosure.

FIG. 11 illustrates a block diagram of a communications manager that supports further considerations on C-WUSs in accordance with one or more aspects of the present disclosure.

FIG. 12 illustrates a diagram of a system including a device that supports further considerations on C-WUSs in accordance with one or more aspects of the present disclosure.

FIGS. 13 through 16 illustrate flowcharts showing methods that support further considerations on C-WUSs in accordance with one or more aspects of the present disclosure.

### DETAILED DESCRIPTION

Wireless communication systems may include indications of communication resources and other information via signaling, such as RRC signaling, for setting up one or more random access procedures. For example, a network entity may transmit one or more synchronization signal blocks (SSB), master information blocks (MIB), or system information blocks (SIB), among other messages, to a user equipment (UE). In some cases, signaling, such as the RRC signaling, may be periodic or may be on-demand. For example, a UE may transmit one or more signals to a network entity requesting SSBs, or SIBs (e.g., SIB1 messages), or both, or may receive an SSB, an SIB, or both, regularly (e.g., periodically). The cell including the UE and the network entity may at times be inactive (e.g., the network entity may be ‘asleep’), and the UE may transmit a wake-up signal (WUS), such as a cell WUS (C-WUS), requesting the network entity to transition to an active state for transmitting signaling, such as an SSB or a SIB. Similarly, the network entity may transmit one or more WUSs to the UE to wake the UE from an inactive state (e.g., a power saving sleep mode). In some examples, the UE may derive different resource information, such as time/frequency/spatial resource information, among other parameters, for transmitting the C-WUS, from the signaling, such as from one or more SSBs. However, signaling periodicity, such as SSB periodicity, may be relatively long when a cell is in an inactive state compared to an active state, and thus relying on some signaling, such as SSBs, for C-WUS transmissions may lead to network delays and missed C-WUS transmissions, among other issues.

Techniques described herein mitigate one or more network delays and missed C-WUS transmissions by enabling a UE to obtain information that may be pertinent for transmitting a C-WUS, for example, using one or more additional signals. For example, a UE may obtain information for C-WUS transmission and associated with a channel (e.g., for updating timing/frequency and path-loss for UL power control of an uplink channel) from signaling, such as a WUS received at a receiver (e.g., a wake-up receiver) of the UE, a synchronization signal (SS), or both. In some examples, the WUS and the SS may represent a low-power WUS (LP-WUS) or a low-power SS (LP-SS) based on a low power consumption of the receiver (e.g., wake-up receiver) at the UE. Based on (e.g., using or accounting for) the information obtained from signaling, such as the LP-WUS or LP-SS transmissions, the UE may transmit a C-WUS to the network entity, and may receive other signaling, such as SSBs/SIBs, and perform other communications via a second receiver with the network entity based on transmitting the C-WUS. The UE may retransmit a C-WUS after failing to receive one or more SSBs/SIBs from the network entity. In some examples, after successfully receiving the other signaling, such as the SSBs/SIBs, the UE and the network entity may communicate further signaling, such as random access channel (RACH) signaling (e.g., via a main receiver/transmitter of the UE) with the network entity using one or more parameters, such as a transmit power, based on the successful C-WUS transmission and, for example, a same uplink spatial filter. The UE may also transmit information, such as PHY configuration updates, within the C-WUS, where the UE may use different sequences/preambles or resource occasions when indicating a C-WUS for waking up the network entity and indicating certain information, such as the PHY configuration updates. As the additional signaling may be more frequent than SSB transmissions during a cell inactivity state, a UE will be able to mitigate delays by deriving information from additional signaling when sending C-WUSs to a network entity.

Aspects of the disclosure are initially described in the context of wireless communications systems. Aspects of the disclosure are further illustrated by and described with reference to signaling diagrams and process flows. Aspects of the disclosure are further illustrated by and described with reference to apparatus diagrams, system diagrams, and flowcharts that relate to further considerations on C-WUSs.

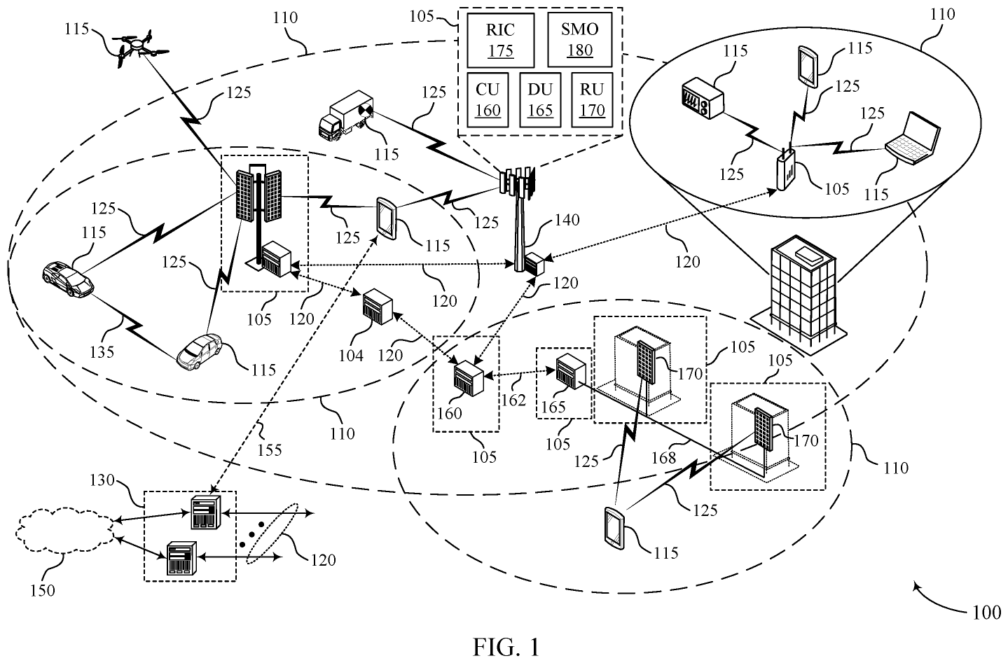

FIG. 1 illustrates an example of a wireless communications system 100 that supports further considerations on C-WUSs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (MC) 175 (e.g., a Near-Real Time MC (Near-RT RIC), a Non-Real Time MC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support further considerations on C-WUSs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Additionally, or alternatively, the network entity 105 may transmit one or more SSBs and/or other blocks to the UE 115, and the UE 115 may provide feedback for beam selection. Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a UE 115 and a network entity 105 may perform one or more random access procedures as part of initial access (e.g., to set up a communication link 125). For example, a UE 115 and a network entity 105 may perform a 4-step RACH setup procedure, where the UE 115 may transmit a RACH preamble (MSG1), and the network entity 105 may respond with a random access response (RAR) message (MSG2). In response to the RAR, the UE 115 may transmit a physical uplink channel (PUSCH) message (MSG3), and the network entity 105 may respond with a contention resolution message (MSG4). In some cases, RACH setup may be a two-step process, where MSG1 and MSG3 may be transmitted together, and where MSG2 and MSG4 may also be transmitted together. RACH procedures may also be referred to as physical RACH (PRACH) procedures due to the use of one or more physical channels. After performing RACH setup, a UE 115 may be in a connected mode. In some examples, a UE 115 may transmit a RACH preamble (e.g., MSG1 or MSG1 and MSG3 combined) after performing beamforming with a network entity 105.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include operating using a limited bandwidth (e.g., according to narrowband communications. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier. Additionally, or alternatively, a UE may enter a power saving inactive state, or a “sleep” mode, when not engaging in active communications. A UE sleep mode may define a limited set of communications to be performed (e.g., for a limited set of processes, channels, subcarriers or RBs, and the like) compared to a greater quantity of communications performed during an active state. In some examples, the UE 115 may enter a light sleep mode or may enter a deep sleep mode, where a deep sleep mode may include significantly more limited communications compared to a light sleep mode. Similarly, a network entity 105 (e.g., a gNB) may also enter an inactive state, such as a light sleep mode or a deep sleep mode, to conserver power by limiting communications, limiting channels, using different protocols, and the like as described herein.

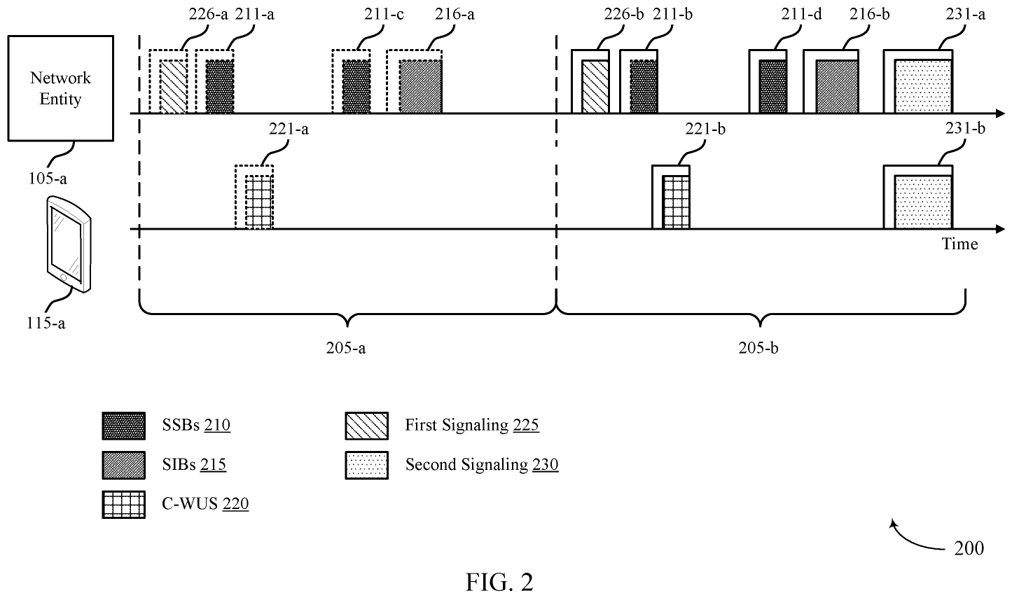

In some examples, a UE 115 may transition from an inactive state to an active state in response to one or more commands. For example, a UE 115 may receive a WUS from a network entity 105 or another UE 115, where the WUS may trigger the UE 115 to “wake” to resume one or more communications or operations. Similarly, a network entity 105 (e.g., a gNB) may receive one or more WUSs to transition to an active state. For example, a UE 115 may transmit a C-WUS to the network entity 105 requesting the network entity 105 to transition from an inactive state to an active state to transmit or receive one or more signals as described with reference to FIG. 2.

The wireless communications system 100 may support RRC signaling for setting up one or more random access procedures. For example, a network entity 105 may transmit one or more MIBs, followed by one or more SIBs, SSBs, or other signals, to a UE 115 before performing RACH communications (e.g., as well as beamforming). In some cases, signaling such as RRC signaling may be periodic, or may be on-demand. For example, a network entity 105 may be in an inactive state (e.g., corresponding cell may be inactive), and may refrain from transmitting one or more blocks such as SSBs or SIBS as part of RRC signaling for RACH setup. To begin RRC signaling, the UE may transmit a C-WUS to the network entity 105 requesting the network entity 105 to transition to an active state to transmit SSBs, SIBS, or both. However, to transmit the C-WUS, the UE may first derive information from one or more SSBs, which may be infrequently transmitted by the network entity 105 during the inactive state. Thus, waiting for infrequent signaling before transmitting a C-WUS may lead to network delays or missed C-WUS transmissions, which may delay RACH setup among other signaling.

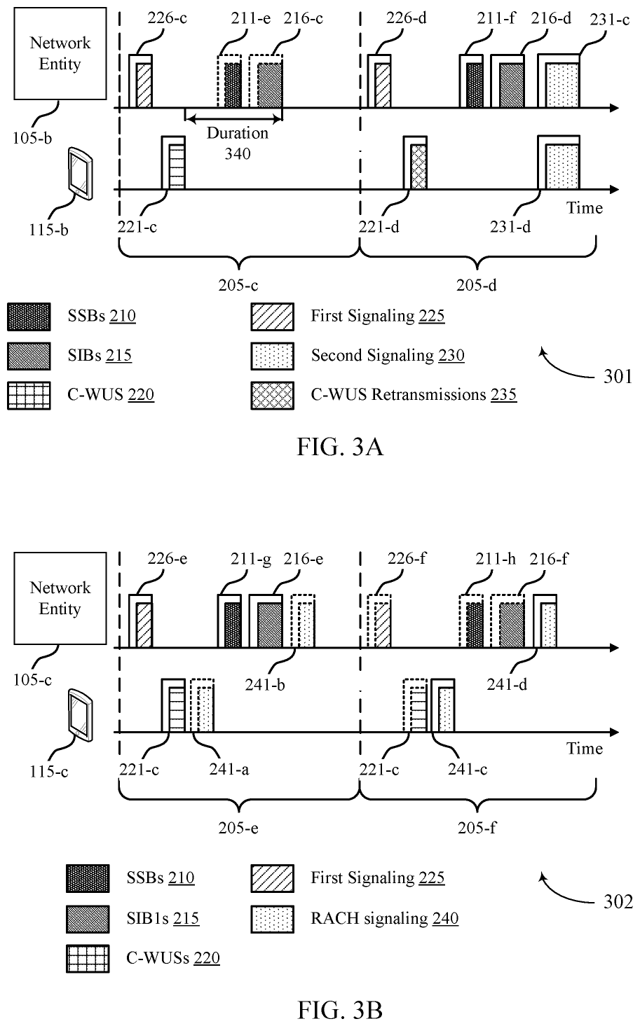

Techniques described herein mitigate one or more network delays and missed C-WUS transmissions by enabling a UE 115 to obtain information for transmitting a WUS using one or more additional signals. For example, a UE 115 may obtain information for a C-WUS transmission (e.g., timing/frequency and path-loss for UL power control) from a WUS (e.g., an LP-WUS) or a synchronization signal (e.g., an LP-SS) transmitted by the network entity. Using the information obtained from the LP-WUS or LP-SS transmissions, the UE may transmit a C-WUS to the network entity, and may receive SSB s/SIB s and perform other communications with the network entity. The UE may additionally retransmit a C-WUS after failing to receive one or more SSB s/SIB s from the network entity, as well as transmit PHY configuration information and perform RACH using the information as described with respect to FIGS. 2 and 3A-3B.

FIG. 2 illustrates an example of a signaling diagram 200 that supports further considerations on C-WUSs in accordance with one or more aspects of the present disclosure. The signaling diagram 200 may illustrate an example for implementing one or more aspects of the wireless communications system 100. For example, the signaling diagram 200 may illustrate a network entity 105-a and a UE 115-a of a wireless communication system 100, which may represent examples of the network entities 105 and the UEs 115 as described with reference to FIG. 1. In some examples, the network entity 105-a and the UE 115-a may exchange control information, data, or both using one or more channels, and may be part of a same cell (e.g., with a coverage area 110) as described with reference to FIG. 1. For example, periodic signaling, aperiodic (e.g., dynamic) signaling, or both, may be transmitted during one or more durations 205, where the durations 205 may be defined by or related to one or more periods. The signaling diagram 200 may support obtaining information associated for C-WUS transmission from one or more signals.

In some examples, the UE 115-a may receive downlink signaling, such as RRC signaling, from the network entity 105-a as described with reference to FIG. 1. For example, the UE 115-a may receive an SSB 210, an SIB 215, or both, among other signaling from the network entity 105-a. In some cases, the UE 115-a may receive SSBs 210 and SIBs 215 periodically. For example, the UE 115-a may receive an SSB at an SSB occasion 211-a at the beginning of a duration 205-a, and an SSB at an SSB occasion 211-b at the beginning of a duration 205-b, where the SSB occasions 211-a and 211-b may be separated by a first period equal to the length of the durations 205. Similarly, the UE 115-a may receive an SIB (e.g., SIB1 message) 215 periodically during each duration 205. For example, the network entity 105-a may transmit an SIB at an SIB occasion 216-a during the duration 205-a and an SIB at an SIB occasion 216-b during the duration 205-b.

Additionally, or alternatively, the UE 115-a may receive downlink or RRC signaling on-demand (e.g., dynamically). For example, the network entity 105-a may be in an inactive state, such as a light or deep sleep mode. At a C-WUS occasion 221-a, the network entity 105-a may transition to an active state to monitor for and receive any transmitted C-WUSs 220. The UE 115-a may not yet be configured with any SSBs 210 within the cell, or may monitor for and fail to detect any transmitted SSBs 210, and may thus transmit a C-WUS 220 at the C-WUS occasion 221-a to request an SSB 210, an SIB1 215, or both. In response to receiving the C-WUS 220, the network entity 105-a may remain in an active state and may transmit the requested SSB and SIB at an SSB occasion 211-c and an SIB occasion 216-a following the C-WUS occasion 221-a. The UE 115-a may receive (e.g., detect) the SSB 210, and may monitor for and receive the SIB 215 in response to receiving the SSB 210. In some cases, the network entity 105-a may refrain from transmitting SSBs 210 or SIBs 215 unless the network entity 105-a receives a C-WUS 220 during a C-WUS occasion 221 (e.g., requesting the SSB and the SIB). In some examples, the SSBs 210 and the SIBs 215 may be transmitted according to any combination of periodic and aperiodic, or dynamic, signaling.

In some examples, the UE 115-a may acquire information (e.g., C-WUS configuration information) for transmitting the C-WUS 220 to the network entity 105-a. For example, the UE 115-a may be configured with information for a physical uplink channel, where the information may include timing information, path-loss information, time/frequency/spatial resource information, among other information associated with the channel for transmitting the C-WUS 220 to the network entity 105-a. The information may also include a transmit power, uplink spatial filters, subcarrier spacings, among other parameters. In some examples, the information may represent information for updating one or more parameters for C-WUS transmission.

Additionally, or alternatively, the UE 115-a may obtain the information from the network entity 105-a. For example, the UE 115-a may receive one or more additional SSBs 210 from the network entity 105-a indicating timing, path-loss information, resource information, subcarrier spacings, transmit powers, uplink spatial filters, etc. for C-WUS transmission. Thus, the UE 115-a may transmit a C-WUS 220 to the network entity 105-a based on (e.g., using or accounting for) the information. For example, the UE 115-a may transmit the C-WUS 220 at a correct timing of the C-WUS occasions 221 when the network entity 105-a is in an active state for reception. By way of another example, the UE 115-a may transmit the C-WUS 220 using an uplink spatial filter for uplink power control (e.g., in a multi-beam scenario) by selecting, using, or accounting for information received in other signaling such as lower-power signaling, may transmit the C-WUS 220 over one or more stable frequencies to enable the network entity 105-a to receive the C-WUS 220 successfully, or both.

However, information may be transmitted relatively infrequently by the network entity 105-a. For example, the network entity 105-a may transmit SSBs 210 according to a longer periodicity (e.g., 80 ms or 160 ms) when the network entity 105-a is in an inactive state. In FIG. 2, the network entity 105-a may transmit an SSB 210 during the SSB occasion 211-a, but not at the SSB occasion 211-b due to the longer periodicity of the SSB transmissions. Thus, C-WUS transmissions may be delayed from the UE 115-a as the UE 115-a may first rely on receiving the relatively infrequent SSB transmissions from the network entity 105-a, leading to an increased latency in communications and delays in one or more later processes (e.g., RACH). Further, the network entity may rely on a receiving a C-WUS 220 to wake up and send an SSB 210 and an SIB 215 to the UE 115-a (e.g., when performing dynamic SSB/SIB transmissions). Thus, in dynamic transmissions, the UE 115-a may not receive any SSBs during the SSB occasion 211-a (or any SSB occasion 211) and may be unable to obtain information for a C-WUS transmission. Although the UE 115-a may attempt to transmit a C-WUS 220 to the network entity 105-a, at the C-WUS occasion 221-a, the network entity 105-a may fail to receive the C-WUS 220 as the UE 115-a was unable to obtain the information. For example, the C-WUS 220 may be transmitted based on a desynchronized time (e.g., transmitted while the network entity 105-a is asleep) or according to incorrect channel parameters.

The techniques described herein enable a UE 115 to obtain information for C-WUS transmissions using one or more additional signals. For example, during an inactive state, the network entity 105-a may transmit first signaling 225 including one or more signals, such as LP-SSs, LP-WUSs, among other signaling. The first signaling may be transmitted periodically, for example, at one or more first signaling occasions 226, including first signaling occasions 226-a and 226-b. The UE 115-a may receive the first signaling (e.g., LP-SS and/or LP-WUS), for example, at the first signaling occasion 226-b via a first receiver of the UE 115-a (e.g., a wake-up receiver). In some examples, the UE 115-a may receive the first signaling via a first receiver of the UE 115-a, such as a wake-up receiver. The UE 115-a may derive information from the signals, and may successfully transmit a C-WUS 220 to the network entity 105-a at the C-WUS occasion 221-b using the information. Based on the C-WUS 220, the network entity 105-a may transmit one or more signals, including an SSB 210 at the SSB occasion 211-d and an SIB 215 (e.g., an SIB1 message) at the SIB occasion 216-b. The UE 115-a may monitor one or more channels for receiving the SSB and the SIB, and based on successfully receiving the SSB 210 and SIB 215, the UE 115-a and the network entity 105-a may communicate second signaling 230 (e.g., using a second receiver of the UE 115-a, such as a main receiver/transmitter) at one or more second signaling occasions 231 (e.g., 231-a and 231-b) as described with respect to FIG. 3B. In some examples, the UE 115-a may monitor a physical broadcast channel (PBCH) for receiving the SSB 210, and may monitor a physical downlink shared channel (PDSCH) for receiving the SIB 215.

In some cases, the UE 115-a may obtain the information for C-WUS transmissions based on an association between the first signaling 225 and the information. For example, the UE 115-a may be configured with an association between LP-WUS (or LP-SS) resources and C-WUS resources. Additionally, or alternatively, the UE 115-a may receive information indicating such an association (e.g., in an C-WUS configuration message).

In some examples, the UE 115-a may obtain the information for C-WUS transmissions based on receiving the LP-SS, the LP-WUS, or both. For example, the UE 115-a may include a main receiver (or main transmitter, or both) operable to receive signals across one or more downlink channels (or transmit signals across one or more uplink channels). The UE may also include a wake-up receiver, where the wake-up receiver may be operable to receive one or more WUSs (e.g., LP-WUS) or synchronizations signals (e.g., LP-SS). The UE 115-a may also be in a sleep mode during the operations described herein. For example, the UE 115-a may be in an inactive RRC state, or in a dormant state in RRC connected mode with the network entity 105-a. During the sleep mode, the UE 115-a may deactivate the main receiver by setting the main receiver to an ultra-deep sleep mode (e.g., including 0.015 of the power consumption of a deep sleep mode). Also during the sleep mode, the UE 115-a may activate the wake-up receiver periodically to monitor for and potentially receive one or more WUSs. In some examples, the wake-up receiver may be a lower power receiver, and may have a much lower power consumption when active compared to the main receiver. For example, the activated wake-up receiver may have a power consumption less than or equation to 1/10 of a power consumption of the main receiver when the main receiver is active. In some examples, the LP-SS and the LP-WUS may be low power signals based on the LP-SS and the LP-WUS being associated with a low power receiver, such as the wake-up receiver.

Further, the UE 115-a may activate the wake-up receiver periodically based on a synchronization performed using a previously received LP-SS. For example, the UE 115-a may receive and use an LP-SS (e.g., via the wake-up receiver or another receiver) to synchronize time/frequency/spatial tracking information for later receiving the LP-WUS via the wake-up receiver. The UE 115-a may then receive the LP-WUS at the first signaling occasion 226-b according to the synchronization, and may obtain the information for C-WUS 220 transmission from the LP-WUS. For example, the UE 115-a may derive one or more time/frequency/spatial resources from a channel the C-WUS 220 was received on, or may determine transmit power, path-loss information, an uplink spatial filter, or any combination thereof, from a receive power or other parameters of the LP-WUS. After the UE 115-a receives the LP-WUS, the UE 115-a may activate the main receiver for transmitting a C-WUS 220 to the network entity 105-a during the C-WUS occasion 221-b and using the derived information. The LP-SS and the LP-WUS may be transmitted to the UE 115-a according to a shorter periodicity than one or more SSBs 210. In some examples, the UE 115-a may perform a mobility procedure, including selecting a new cell (e.g., a new coverage area 110) using the LP-SS, the LP-WUS, or both. For example, the LP-WUS may be transmitted from the network entity 105-a (or another device of a wireless communications system 100) to the UE 115-a based on performing paging procedures with the UE 115-a. In some examples, the UE 115-a may determine (e.g., derive) the information for the C-WUS 220 transmission from the LP-SS, and the UE 115-a may refrain from receiving an LP-WUS.

In some examples, the UE 115-a may transmit information within a C-WUS 220. For example, in addition to or in place of using a C-WUS 220 to indicate to the network entity 105-a to transition to an active state (e.g., for transmitting SSBs 210 and SIBs 215), the UE 115-a may include physical layer (PHY) configuration information within a C-WUS 220. For example, the UE 115-a may include PHY information for updating an antenna configuration, updating a downlink power of transmissions from the network entity 105-a, among other information. In a representative example, the UE 115-a may, under a dynamic antenna port adaptation at the network entity 105-a, evaluate PDSCH performance by performing one or more measurements on PDSCH signals (e.g., reference signals) received at the UE 115-a according to different antenna port configurations. Based on the measurements, the UE 115-a may select an antenna port configuration associated with one or more beneficial parameters (e.g., a highest RSRP or greatest stability in communications), and may include an indication of (or a request to use) the selected antenna port configuration in the transmitted C-WUS 220 (e.g., at the C-WUS occasion 221-b).

In some examples, after receiving the C-WUS 220, the network entity 105-a may transmit updated channel state information (CSI) to the UE 115-a based on the selected antenna port configuration. For example, the network entity 105-a may transmit one or more reference signals indicating an updated reference signal configuration. In some examples, the UE 115-a may differentiate between using the C-WUS 220 to indicate a transition to an active state, or using the C-WUS 220 to indicate PHY configuration updates, or both, by using a different coding sequence or preamble as well as different time/frequency/spatial resource occasions. For example, the UE 115-a may utilize the C-WUS occasion 221-a to indicate PHY configuration updates, and may utilize the C-WUS occasion 221-b to request SSBs 210 and SIBS 215. In some cases, the network entity 105-a may refrain from transmitting the SSBs 210 and SIBs 215 in response to a C-WUS 220 if the C-WUS indicates PHY configuration information (e.g., at the C-WUS occasion 221-a), and may transmit updated CSI and transition back into an inactive state until a next C-WUS occasion 221.

The techniques described herein enable the UE 115-a and the network entity 105-a to communicate successfully. For example, by obtaining the information from the LP-SS, the LP-WUS, or both, the UE 115-a may successfully transmit a C-WUS 220 at the C-WUS occasion 221-b, enabling the network entity 105-a to successfully transmit SSBs 210 and SIBs 215 to the UE 115-a during dynamic signaling. Further, the techniques described herein mitigate delays to communications by basing C-WUS transmissions on signaling with more frequent periods opposed to using less frequent SSB signaling. In some cases, the UE 115-a may fail to receive the SSB or the SIB1, and may retransmit a C-WUS 220 as described with reference to FIG. 3A. Further, after receiving an SSB 210 and an SIB 215 from the network entity 105-a, the UE 115-a and the network entity 105-a may perform one or more RACH procedures as described with reference to FIG. 3B. The UE 115-a and the network entity 105-a may additionally be part of a multi-beam operation, where a multi-beam operation may include the use of different beams of a set of multiple beams based on performing one or more beamforming procedures as described with respect to FIGS. 1 and 3B.

FIGS. 3A and 3B illustrate examples of signaling diagrams 301 and 302 that support further considerations on C-WUSs in accordance with one or more aspects of the present disclosure. The signaling diagrams 301 and 302 may illustrate examples of signaling in the wireless communications system 100 or the signaling diagram 200 described with reference to FIGS. 1 and 2. For example, the signaling diagram 301 may represent signaling between a UE 115-b and a network entity 105-b, and the signaling diagram 302 may represent signaling between a UE 115-c and a network entity 105-c, which may represent examples of the UE 115-a and the network entity 105-a described with reference to FIG. 2. FIG. 3A may represent a C-WUS retransmission process during durations 205-c and 205-d, while FIG. 3B may represent a RACH setup procedure following C-WUS transmission during durations 205-e and 205-f.

In FIG. 3A, the UE 115-b and the network entity 105-b may exchange first signaling 225 and C-WUSs 220 as described with respect to FIG. 2. For example, the network entity 105-b may transmit first signaling 225 at a first signaling occasion 226-c, and the UE 115-b may transmit a C-WUS 220 to the network entity 105-b at a C-WUS occasion 221-c using information determined (e.g., derived) based on an LP-SS and an LP-WUS in the first signaling 225. In some examples, the network entity 105-b may fail to receive the C-WUS 220. For example, the network entity 105-b may encounter one or more errors in decoding the C-WUS 220, may encounter interference with one or more additional signaling (e.g., from other UEs 115), may encounter scheduling conflicts, or may fail to wake up in time to receive the C-WUS 220, among other error conditions.

Additionally, or alternatively, the UE 115-b may encounter one or more errors in transmission of the C-WUS 220 which may result in the network entity 105-b failing to receive the C-WUS 220. For example, the UE 115-b may be at a cell edge or out of range of the network entity 105-b, may be in the process of a hand-over procedure, or may encounter one or more errors in reception of the first signaling 225, among other error scenarios. Thus, the network entity 105-b may fail to transmit one or more SSBs or SIBs, for example, at an SSB occasion 211-e and an SIB occasion 216-c, based on the failed C-WUS reception. Additionally, or alternatively, the network entity 105-b may successfully transmit an SSB and an SIB, and the UE 115-b may fail to receive the SSB and the SIB due to one or more factors (e.g., interference, scheduling conflicts, and the like).

In some examples, the UE 115-b may send a C-WUS retransmission 235 based on the UE 115-b failing to receive one or more SSBs or SIBs. For example, the UE 115-b may monitor one or more channels (e.g., a PBCH, a PDCSCH, or both) for receiving an SSB 210, an SIB 215, or both, during a duration 340 after transmission of the C-WUS 220 at the C-WUS occasion 221-c. Based on failing to detect or receive at least one SSB or SIB during the duration 340, the UE 115-b may send the C-WUS retransmission 235. For example, the UE 115-b may perform retransmission at a next C-WUS occasion 221-d. Additionally, or alternatively, the UE 115-b may perform the retransmission within the same duration 205-c as the first C-WUS transmission and after the duration 340. Thus, the network entity 105-a may receive the C-WUS retransmission 235, and may successfully transmit an SSB at an SSB occasion 211-f and an SIB (e.g., an SIB1 message) at an SIB occasion 216-d, and may exchange second signaling 230 with the UE 115-b at second signaling occasions 231-c and 231-d.

In some examples, the duration 340 may represent a time window, where the UE 115-b may transmit the C-WUS retransmission 235 after failing to receive the requested SSB/SIB within a quantity of symbols of the time window. By way of another example, the duration 340 may represent an expiration of a timer. For example, the UE 115-b may send the C-WUS retransmission 235 after failing to receive the requested SSB 210 and SIB 220 before an expiration of the timer (e.g., counted by a quantity of symbols). In some cases, a size (e.g., quantity of symbols or time in seconds) of the time window or a length of the timer (e.g., in symbols or seconds) may be defined at the UE 115-b, or may be indicated to the UE 115-b via signaling (e.g., from the network entity 105-b).

The UE 115-b may send the C-WUS retransmission 235 based on (e.g., using) the information determined from the first signaling 225 received at the first signaling occasion 226-c. For example, the UE 115-b may utilize same path-loss information or same timing/frequency/space resources used in transmitting the C-WUS in the first duration 205-c. Additionally, or alternatively, the UE 115-b may obtain new information, for example, from additional first signaling 225 transmitted at a first signaling occasion 226-d, and may send the C-WUS retransmission 235 using the new information.

In a further example, the UE 115-b may use a same or different uplink spatial filter, transmit power, subcarrier spacing, other parameter, or any combination thereof. For example, the UE 115-b may determine an uplink spatial filter, where an uplink spatial filter may represent a filter for selecting one or more spatial resources based on beamforming. The UE 115-b may also determine a subcarrier spacing for the initial C-WUS 220 transmission during the C-WUS occasion 221-c, where the timer and time window may be based on the subcarrier spacing. The UE 115-b may thus utilize the same uplink spatial filter for sending the C-WUS retransmission 235 and may base the timer and the time window off of a same subcarrier spacing. Alternatively, the UE 115-b may utilize a different uplink spatial filter, a different subcarrier spacing, or both. For example, the UE 115-b may select a new uplink spatial filter or subcarrier spacing from one or more subcarrier spacings and/or uplink spatial filters configured at the UE 115-b, or received in a C-WUS configuration. Additionally, or alternatively, the UE 115-b may utilize any combination of uplink spatial filters, subcarrier spacings, and other parameters (e.g., transmit powers) for the retransmission. In some examples, the subcarrier spacing, the uplink spatial filter, or both may be based on successfully receiving the SSB 210, the SIB 215, or both.

In FIG. 3B, the UE 115-c and the network entity 105-c may exchange first signaling 225, C-WUSs 220, SSBs 210, and SIBs 215, as described with respect to FIG. 2. For example, the UE 115-c may receive, from the network entity 105-c, first signaling 225 at a first signaling occasion 226-e and may transmit a C-WUS 220 at a C-WUS occasion 221-c. The network entity 105-c may respond to the C-WUS 220 by transmitting, to the UE 115-c, an SSB 210 at an SSB occasion 211-g and an SIB at an SIB occasion 216-e.

In some examples, the UE 115-c and the network entity 105-c may perform a RACH procedure by exchanging RACH signaling 240 based on the successful C-WUS and SSB/SIB transmissions. For example, in each duration 205, the UE 115-c and the network entity 105-c may include a random access occasion 241. In an example, the UE 115-c, based on successfully receiving the SSB 210 and the SIB 215 during the first duration 205-e, may transmit RACH signaling using a device of the UE 115-a (e.g., a main receiver/transmitter) at a next RACH occasion after receiving the downlink signaling. The UE 115-c may refrain from performing RACH at an earlier random access occasion 241-a in the duration 205-e as this may come before receiving the SSB 210 and the SIB 215 at the SSB occasion 211-g and the SIB occasion 216-e. Similarly, the network entity 105-c may refrain from performing RACH at a RACH occasion 241-b as the network entity 105-c may wait until receiving a RACH signal (e.g., MSG1) from the UE 115-c. Thus, the UE 115-c may transmit a MSG1 (or MSG1 with a MSG3) at a random access occasion 241-c in the next duration 205-f. The network entity 105-c may transmit RACH signaling in response to the MSG1, for example, by transmitting a MSG2 (or MSG2 with a MSG4) at a random access occasion 241-d. As the UE 115-c and the network entity 105-c may be occupied with RACH signaling during the duration 205-f, the UE 115-c and the network entity 105-c may refrain from exchanging first signaling 225, C-WUSs 220, SSBs 210 and SIBS 215 at a first signaling occasion 226-f, a C-WUS occasion 221-c, an SSB occasion 211-h, and a SIB occasion 216-f.

In some examples, the UE 115-c and the network entity 105-c may determine one or more parameters for RACH setup procedures based on the successful signaling in the first duration 205-e. For example, the UE 115-c may determine a power for RACH (e.g., PRACH) transmission at the random access occasion 241-c based on a power of the successfully transmitted C-WUS 220. Additionally, or alternatively, the UE 115-c may utilize a same uplink spatial filter for RACH transmissions as an uplink spatial filter used for transmitting the C-WUS 220. Similarly, the network entity 105-c may utilize one or more same parameters or base a power of RACH transmissions on the successfully transmitted SSB 210 and SIB 215 in the first duration 205-e. The UE 115-c and the network entity 105-c may also base parameters for RACH transmissions on the successful C-WUS, SSB, and SIB transmissions and in accordance with the information used for the successful C-WUS transmission.

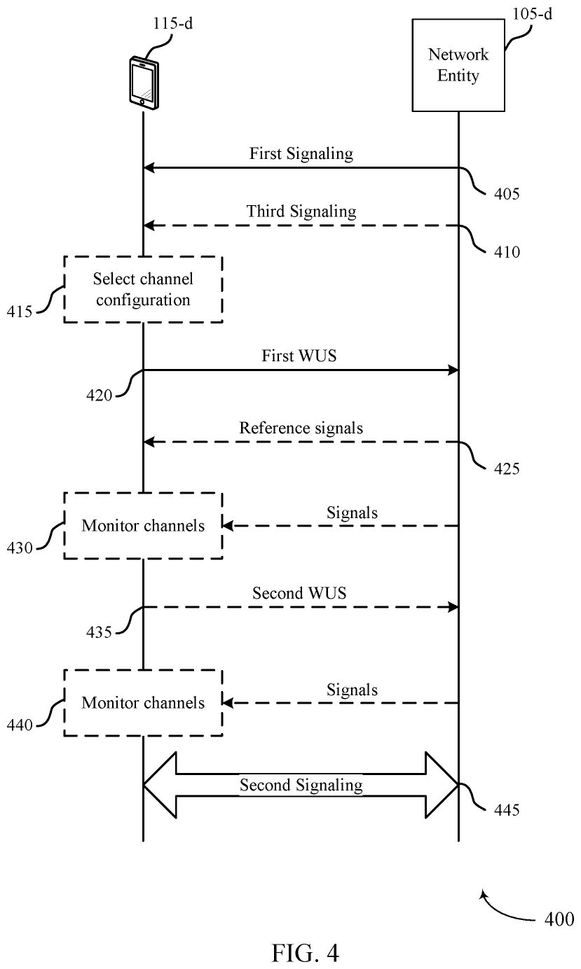

FIG. 4 illustrates an example of a process flow 400 that supports further considerations on C-WUSs in accordance with one or more aspects of the present disclosure. In some examples, the process flow 400 may implement aspects of the wireless communications system 100 and the signaling diagrams 200, 301, and 302. For example, the process flow 400 may illustrate an example of a network entity 105 and a UE 115 exchanging first signaling 225, C-WUSs 220, SSBs 210, SIBS 215, and second signaling 230 with one or more durations 205. The network entity 105-d and the UE 115-d may be examples of a network entity 105-a, 105-b, or 105-c and a UE 115-a, 115-b, and 115-c, respectively, as described with reference to FIGS. 2-3B.

Alternative examples of the following may be implemented, where some processes are performed in a different order than described or are not performed. In some cases, processes may include additional features not mentioned below, or further processes may be added.

At 405, the network entity 105-d may transmit, and the UE 115-d may receive via a first receiver (e.g., a wake-up receiver), first signaling. For example, the UE 115-d may receive first signaling 225 (e.g., LP-SS and/or LP-WUS) from the network entity 105-d in preparation of communicating second signaling at 445 via a second receiver (e.g., main receiver and/or transmitter). In some examples, the UE 115-d may receive the first signaling via the first receiver, where the first receiver may use a power below a second power associated with the second receiver. For example, the UE 115-d may receive a WUS (e.g., an LP-WUS) using a low power receiver, such as a wake-up receiver, where the wake-up receiver may have a power consumption much lower than a main receiver (e.g., 10 times lower, or 1/10 power consumption).

At 410, the network entity 105-d may optionally transmit, and the UE 115-dmay optionally receive, third signaling including downlink signaling via a downlink channel. For example, the UE 115-d may receive one or more reference signals or other signaling within the downlink channel using different antenna port configurations as described with reference to FIG. 2, and may select a channel configuration (e.g., antenna port configuration, downlink transmit power) at 415. In some examples, the downlink channel may be a PDSCH.

At 420, the UE 115-d may transmit, and the network entity 105-d may receive, a first WUS (e.g., a C-WUS) based on (e.g., using or based on) information determined based on receiving the first signaling at 405. For example, the UE 115-d may determine information from an LP-SS or an LP-WUS, where the information may be associated with a channel (e.g., an uplink channel for transmitting a C-WUS). The UE 115-d may transmit a C-WUS 220 at a C-WUS occasion 221 using one or more resources, transmit powers, path-loss information, uplink spatial filters, subcarrier spacings, and other information determined from the first signaling 225. For example, the information may include timing/frequency/spatial resource information, path-loss information, one or more transmit powers, uplink spatial filters, subcarrier spacings, and the like.

In some examples, the UE 115-d may transmit, within the first WUS, channel configuration information associated with the downlink channel. For example, the UE 115-d may transmit an indication of the selected channel configuration (e.g., PHY configuration including antenna port configuration, downlink transmit power, or both) based on performing the one or more measurements associated with a PDSCH. The one or more measurements may be performed based on receiving the third signaling including downlink signaling at 410. In response to receiving the channel configuration information at 420, the network entity 105-d may transmit, and the UE 115-d may receive, one or more one or more reference signals at 425. For example, the UE 115-d may receive one or more CSI-RSs defining an updated CSI-RS configuration in response to the selected channel configuration. In some examples, the reference signals may be transmitted in addition to or in place of one or more signals transmitted at 430.

In some examples, the first WUS, including the channel configuration information, may be based on one or more first coding sequences, one or more first preambles, one or more first resource occasions, or any combination thereof, associated with indicating the channel configuration information. Further, the first coding sequences, preambles and resource occasions may be different from one or more one or more second coding sequences, one or more second preambles, or one or more second resource occasions associated with a wake-up procedure of the network entity 105-d.

At 430, the UE 115-d may optionally monitor one or more channels, during a duration, for one or more signals based on transmitting the first WUS. For example, the UE 115-d may monitor a PBCH, a PDSCH, or both, for receiving an SSB 210 and an SSB 210. In some examples, the UE 115-d may transmit a second WUS (e.g., a WUS retransmission) at 435 after the duration based on failing to receive the one or more signals via the one or more channels during the duration as described with reference to FIG. 3A. For example, the UE 115-d may perform the monitoring during a time window and may send a C-WUS retransmission 235 based on failing to receive an SSB 210 or an SIB 215 within one or more symbols of the time window. By way of another example, the UE 115-d may activate a timer after transmitting the first WUS, and may transmit the second WUS based on failing to receive an SSB 210 or an SIB 215 before an expiration of the timer. At 440, the network entity 105-d may transmit (or retransmit) one or more signals (e.g., SSB and SIB s) via the one or more channels based on receiving the second WUS after the duration (e.g., after the time window or after the expiration of the timer).

In some examples, the time window, the timer, or both, may be associated with a first subcarrier spacing, where the first subcarrier spacing may be associated with the first WUS, the one or more signals (e.g., SSB and/or SIB), a predefined value, or any combination thereof. In some cases, the second WUS may be transmitted based on the information (e.g., obtained from the first signaling at 405). Alternatively, the second WUS may be transmitted based on second information different from the information.

At 445, the UE 115-d and the network entity 105-d may communicate second signaling based on the transmission of the WUSs based on the information associated. For example, the UE 115-d may communicate the second signaling using a second receiver of the UE 115-d (e.g., a main receiver/transmitter) based on the successful transmissions of the first WUS at 420 and the one or more signals at 430, or based on the successful transmissions of the second WUS at 435 and the one or more signals at 440.

In some examples, the second signaling may include RACH signaling as described with reference to FIG. 3B. For example, the UE 115-d and the network entity 105-d may exchange one or more messages (e.g., MSG1-MSG 4) as part of a RACH setup procedure. RACH signaling may be communicated based on the information, as well as based on the downlink signaling (e.g., SSB, SIB), the reference signals, beamforming, among other previous signaling and procedures.

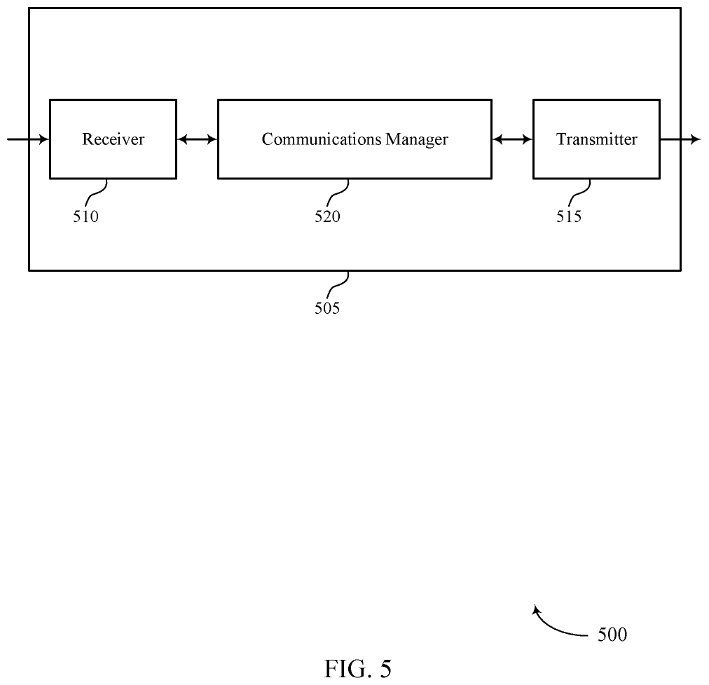

FIG. 5 illustrates a block diagram 500 of a device 505 that supports further considerations on C-WUSs in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to further considerations on C-WUSs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to further considerations on C-WUSs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of further considerations on C-WUSs as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 may be configured as or otherwise support a means for receiving, via a first receiver, first signaling. The communications manager 520 may be configured as or otherwise support a means for transmitting a first WUS based on information associated with a channel, where the information is determined based on receiving the first signaling. The communications manager 520 may be configured as or otherwise support a means for communicating, via a second receiver, second signaling with a network entity based on transmitting the first WUS.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced power consumption, reduced processing, as well as more efficient utilization of communication resources by supporting successful C-WUS transmission and retransmission, as well as PHY configuration updates and reuse of parameters during RACH and other procedures as described herein.

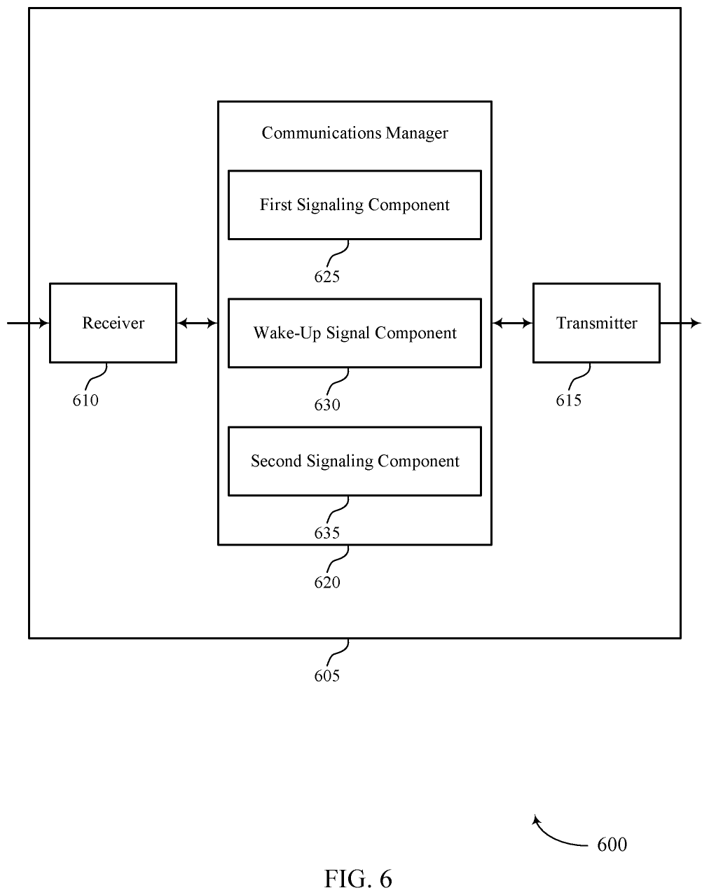

FIG. 6 illustrates a block diagram 600 of a device 605 that supports further considerations on C-WUSs in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to further considerations on C-WUSs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to further considerations on C-WUSs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of further considerations on C-WUSs as described herein. For example, the communications manager 620 may include a first signaling component 625, a wake-up signal component 630, a second signaling component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The first signaling component 625 may be configured as or otherwise support a means for receiving, via a first receiver, first signaling. The wake-up signal component 630 may be configured as or otherwise support a means for transmitting a first WUS based on information associated with a channel, where the information is determined based on receiving the first signaling. The second signaling component 635 may be configured as or otherwise support a means for communicating, via a second receiver, second signaling with a network entity based on transmitting the first WUS.

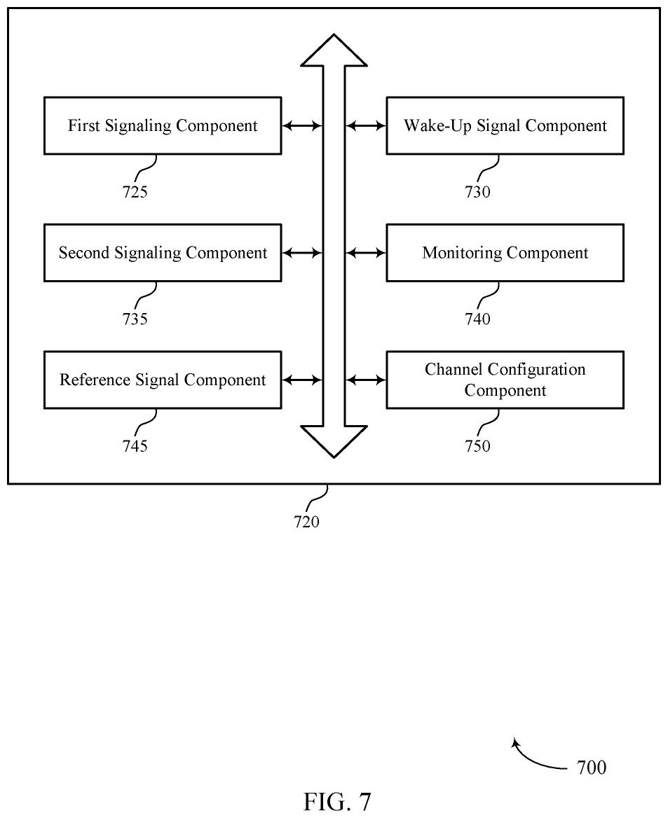

FIG. 7 illustrates a block diagram 700 of a communications manager 720 that supports further considerations on C-WUSs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of further considerations on C-WUSs as described herein. For example, the communications manager 720 may include a first signaling component 725, a wake-up signal component 730, a second signaling component 735, a monitoring component 740, a reference signal component 745, a channel configuration component 750, or any combination thereof. Each of these components may communicate, directly or indirectly, with one another (e.g., via one or more buses).

The communications manager 720 may support wireless communication in accordance with examples as disclosed herein. The first signaling component 725 may be configured as or otherwise support a means for receiving, via a first receiver, first signaling. The wake-up signal component 730 may be configured as or otherwise support a means for transmitting a first WUS based on information associated with a channel, where the information is determined based on receiving the first signaling. The second signaling component 735 may be configured as or otherwise support a means for communicating, via a second receiver, second signaling with a network entity based on transmitting the first WUS.

In some examples, the monitoring component 740 may be configured as or otherwise support a means for monitoring one or more channels, during a duration, for one or more signals based on transmitting the first WUS, where communicating the second signaling with the network entity is based on successfully receiving the one or more signals via the one or more channels during the duration.

In some examples, the monitoring component 740 may be configured as or otherwise support a means for monitoring one or more channels, during a duration, for one or more signals based on transmitting the first WUS. In some examples, the wake-up signal component 730 may be configured as or otherwise support a means for transmitting a second WUS after the duration based on failing to receive the one or more signals via the one or more channels during the duration, where communicating the second signaling with the network entity is based on transmitting the second WUS after the duration.

In some examples, the duration may include a time window, where transmitting the second WUS is based on failing to receive the one or more signals within one or more symbols of the time window; or may include an expiration of a timer, where transmitting the second WUS is based on failing to receive the one or more signals before the expiration of the timer.

In some examples, the time window, the timer, or both, is associated with a first subcarrier spacing, the first subcarrier spacing being associated with the first WUS, the one or more signals, a predefined value, or any combination thereof.

In some examples, the second WUS is transmitted based on the information associated with the channel. In some examples, the second WUS is transmitted based on second information different from the information.

In some examples, the one or more signals include at least an SSB, a signal including an SIB, or both. In some examples, the one or more channels include a physical broadcast channel, a physical downlink shared channel, or both. In some examples, the second WUS includes a retransmission of the first WUS.

In some examples, to support communicating the second signaling with the network entity based on transmitting the first WUS, the second signaling component 735 may be configured as or otherwise support a means for communicating, with the network entity, random access signaling as part of a random access procedure, where the random access signaling is communicated based on the information associated with the channel.

In some examples, to support transmitting the first WUS, the wake-up signal component 730 may be configured as or otherwise support a means for transmitting, within the first WUS, channel configuration information associated with a downlink channel based on performing one or more measurements associated with the downlink channel, the one or more measurements performed based on receiving third signaling including downlink signaling. In some examples, to support transmitting the first WUS, the reference signal component 745 may be configured as or otherwise support a means for receiving one or more reference signals based on transmitting the channel configuration information.

In some examples, to support transmitting the channel configuration information, the channel configuration component 750 may be configured as or otherwise support a means for selecting a channel configuration based on performing the one or more measurements associated with the downlink channel. In some examples, to support transmitting the channel configuration information, the wake-up signal component 730 may be configured as or otherwise support a means for transmitting an indication of the selected channel configuration.

In some examples, the channel configuration information includes at least one of an antenna port configuration, an updated downlink power, or both. In some examples, the downlink channel includes a physical downlink shared channel.

In some examples, the first WUS including the channel configuration information is based on one or more first coding sequences, one or more first preambles, one or more first resource occasions, or any combination thereof, associated with indicating the channel configuration information and different from one or more one or more second coding sequences, one or more second preambles, or one or more second resource occasions associated with a wake-up procedure.

In some examples, to support receiving the first signaling via the first receiver, the first signaling component 725 may be configured as or otherwise support a means for receiving the first signaling via the first receiver, where the first receiver uses a power below a second power associated with the second receiver.

In some examples, the information associated with the channel includes time resource information, frequency resource information, spatial resource information, path loss information, a transmit power, an uplink spatial filter, or any combination thereof, associated with the channel. In some examples, the first signaling includes a WUS, a synchronization signal, or both.

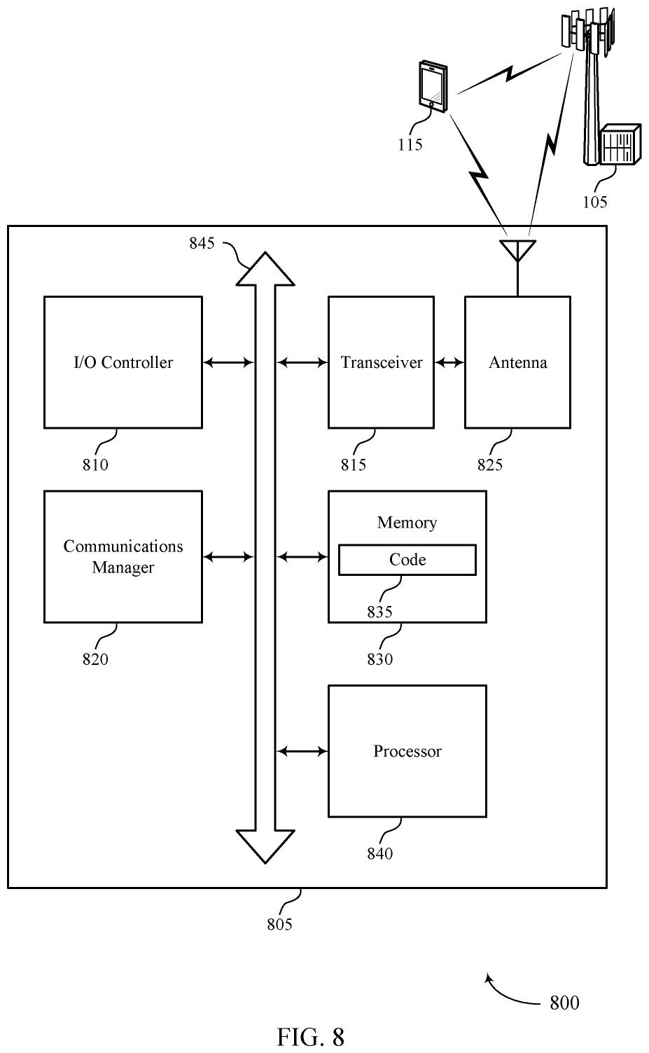

FIG. 8 illustrates a diagram of a system 800 including a device 805 that supports further considerations on C-WUSs in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting further considerations on C-WUSs). For example, the device 805 or a component of the device 805 may include a processor 840 and memory 830 coupled with or to the processor 840, the processor 840 and memory 830 configured to perform various functions described herein.

The communications manager 820 may support wireless communication in accordance with examples as disclosed herein. For example, the communications manager 820 may be configured as or otherwise support a means for receiving, via a first receiver, first signaling. The communications manager 820 may be configured as or otherwise support a means for transmitting a first WUS based on information associated with a channel, where the information is determined based on receiving the first signaling. The communications manager 820 may be configured as or otherwise support a means for communicating, via a second receiver, second signaling with a network entity based on transmitting the first WUS.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, and longer battery life through successful C-WUS transmission and retransmission, as well as PHY configuration updates and reuse of parameters during RACH and other procedures as described herein.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of further considerations on C-WUSs as described herein, or the processor 840 and the memory 830 may be otherwise configured to perform or support such operations.

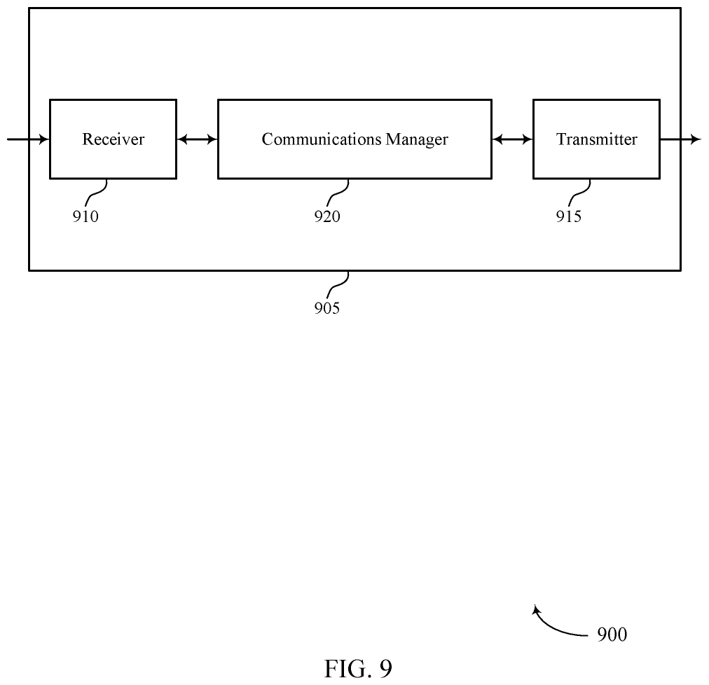

FIG. 9 illustrates a block diagram 900 of a device 905 that supports further considerations on C-WUSs in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., FQ samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., FQ samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of further considerations on C-WUSs as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 may be configured as or otherwise support a means for transmitting first signaling. The communications manager 920 may be configured as or otherwise support a means for receiving a first WUS based on information associated with a channel, where the information is based on the first signaling. The communications manager 920 may be configured as or otherwise support a means for communicating second signaling with a user equipment based on receiving the first WUS.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption, reduced processing, as well as more efficient utilization of communication resources by supporting successful C-WUS transmission and retransmission, as well as PHY configuration updates and reuse of parameters during RACH and other procedures as described herein.

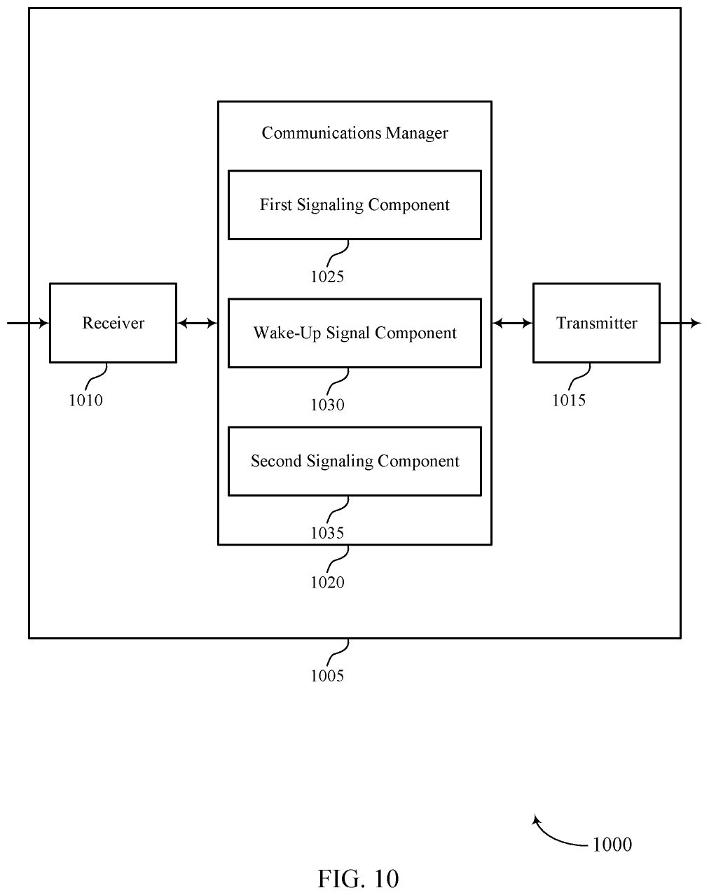

FIG. 10 illustrates a block diagram 1000 of a device 1005 that supports further considerations on C-WUSs in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., UQ samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., UQ samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of further considerations on C-WUSs as described herein. For example, the communications manager 1020 may include a first signaling component 1025, a wake-up signal component 1030, a second signaling component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The first signaling component 1025 may be configured as or otherwise support a means for transmitting first signaling. The wake-up signal component 1030 may be configured as or otherwise support a means for receiving a first WUS based on information associated with a channel, where the information is based on the first signaling. The second signaling component 1035 may be configured as or otherwise support a means for communicating second signaling with a user equipment based on receiving the first WUS.

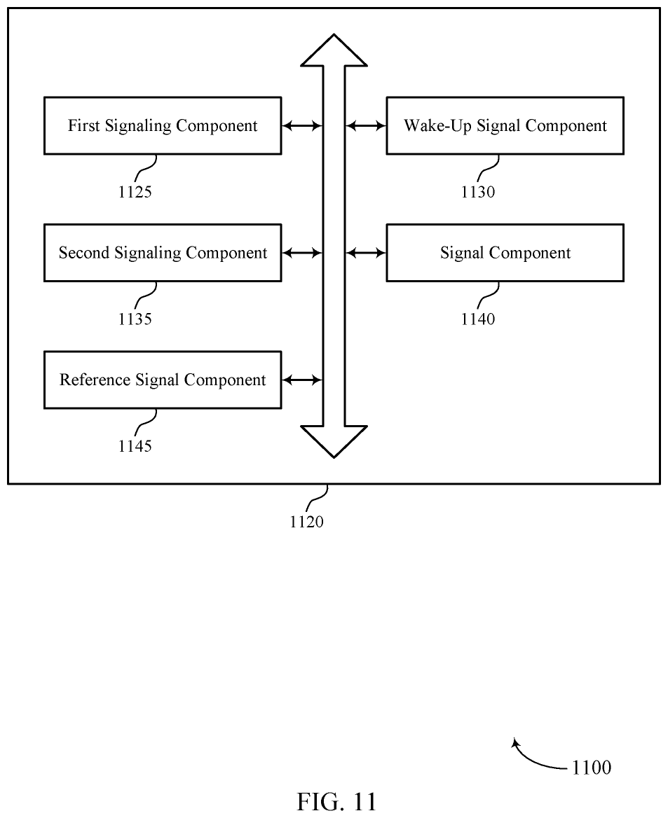

FIG. 11 illustrates a block diagram 1100 of a communications manager 1120 that supports further considerations on C-WUSs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of further considerations on C-WUSs as described herein. For example, the communications manager 1120 may include a first signaling component 1125, a wake-up signal component 1130, a second signaling component 1135, a signal component 1140, a reference signal component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The first signaling component 1125 may be configured as or otherwise support a means for transmitting first signaling. The wake-up signal component 1130 may be configured as or otherwise support a means for receiving a first WUS based on information associated with a channel, where the information is based on the first signaling. The second signaling component 1135 may be configured as or otherwise support a means for communicating second signaling with a user equipment based on receiving the first WUS.

In some examples, the signal component 1140 may be configured as or otherwise support a means for transmitting one or more signals via one or more channels during a duration, where communicating the second signaling with the user equipment is based on transmitting the one or more signals.

In some examples, the wake-up signal component 1130 may be configured as or otherwise support a means for receiving a second WUS after a duration. In some examples, the signal component 1140 may be configured as or otherwise support a means for transmitting one or more signals via one or more channels based on receiving the second WUS after the duration, where communicating the second signaling with the user equipment is based on transmitting the one or more signals via the one or more channels.

In some examples, the duration includes a time window or an expiration of a timer. In some examples, the one or more signals are transmitted after one or more symbols of the time window or after the expiration of the timer.

In some examples, the time window, the timer, or both, is associated with a first subcarrier spacing, the first subcarrier spacing being associated with the first WUS, with the one or more signals, with a predefined value, or any combination thereof.

In some examples, the second WUS is received based on the information associated with the channel. In some examples, the second WUS is received based on second information different from the information.

In some examples, the one or more signals include at least an SSB, a signal including an SIB, or both. In some examples, the one or more channels include a physical broadcast channel, a physical downlink shared channel, or both. In some examples, the second WUS includes a retransmission of the first WUS.

In some examples, to support communicating the second signaling with the user equipment based on receiving the first WUS, the second signaling component 1135 may be configured as or otherwise support a means for communicating, with the user equipment, random access signaling as part of a random access procedure, where the random access signaling is communicated based on the information associated with the channel.

In some examples, to support receiving the first WUS, the wake-up signal component 1130 may be configured as or otherwise support a means for receiving, within the first WUS, channel configuration information associated with a downlink channel based on transmitting third signaling including downlink signaling. In some examples, to support receiving the first WUS, the reference signal component 1145 may be configured as or otherwise support a means for transmitting one or more reference signals based on receiving the channel configuration information.

In some examples, receiving the channel configuration information includes receiving an indication of a selected channel configuration. In some examples, the channel configuration information includes at least one of an antenna port configuration, a downlink power update, or both. In some examples, the downlink channel includes a physical downlink shared channel.

In some examples, the first WUS including the channel configuration information is based on one or more first coding sequences, one or more first preambles, one or more first resource occasions, or any combination thereof, associated with indicating the channel configuration information and different from one or more one or more second coding sequences, one or more second preambles, or one or more second resource occasions associated with a wake-up procedure.

In some examples, the information associated with the channel includes time resource information, frequency resource information, spatial resource information, path loss information, a transmit power, an uplink spatial filter, or any combination thereof, associated with the channel. In some examples, the first signaling includes a WUS, a synchronization signal, or both.

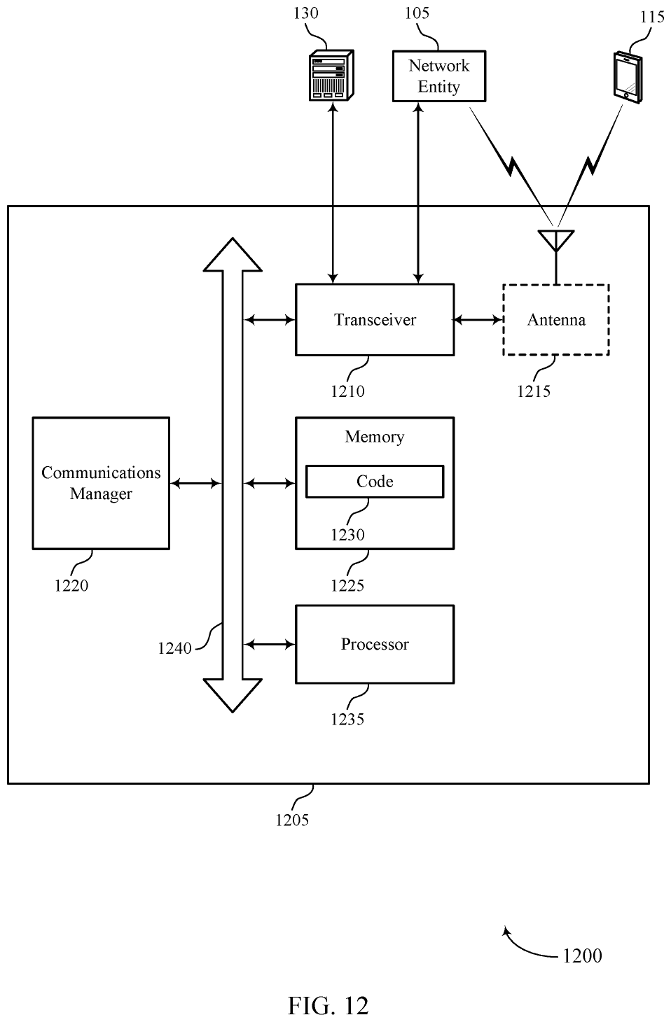

FIG. 12 illustrates a diagram of a system 1200 including a device 1205 that supports further considerations on C-WUSs in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting further considerations on C-WUSs). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 may be configured as or otherwise support a means for transmitting first signaling. The communications manager 1220 may be configured as or otherwise support a means for receiving a first WUS based on information associated with a channel, where the information is based on the first signaling. The communications manager 1220 may be configured as or otherwise support a means for communicating second signaling with a user equipment based on receiving the first WUS.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, and longer battery life through successful C-WUS transmission and retransmission, as well as PHY configuration updates and reuse of parameters during RACH and other procedures as described herein.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of further considerations on C-WUSs as described herein, or the processor 1235 and the memory 1225 may be otherwise configured to perform or support such operations.

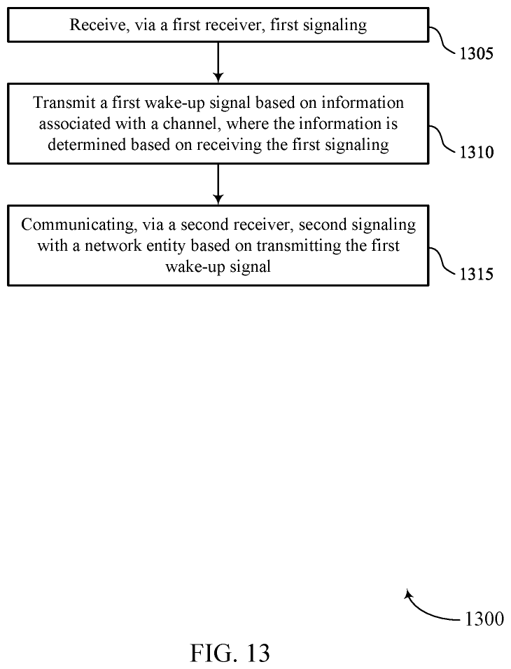

FIG. 13 illustrates a flowchart showing a method 1300 that supports further considerations on C-WUSs in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, via a first receiver, first signaling. The operations of 1305 may be performed in accordance with examples as disclosed herein. In some examples, aspects of the operations of 1305 may be performed by a first signaling component 725 as described with reference to FIG. 7.

At 1310, the method may include transmitting a first WUS based on information associated with a channel, where the information is determined based on receiving the first signaling. The operations of 1310 may be performed in accordance with examples as disclosed herein. In some examples, aspects of the operations of 1310 may be performed by a wake-up signal component 730 as described with reference to FIG. 7.

At 1315, the method may include communicating, via a second receiver, second signaling with a network entity based on transmitting the first WUS. The operations of 1315 may be performed in accordance with examples as disclosed herein. In some examples, aspects of the operations of 1315 may be performed by a second signaling component 735 as described with reference to FIG. 7.

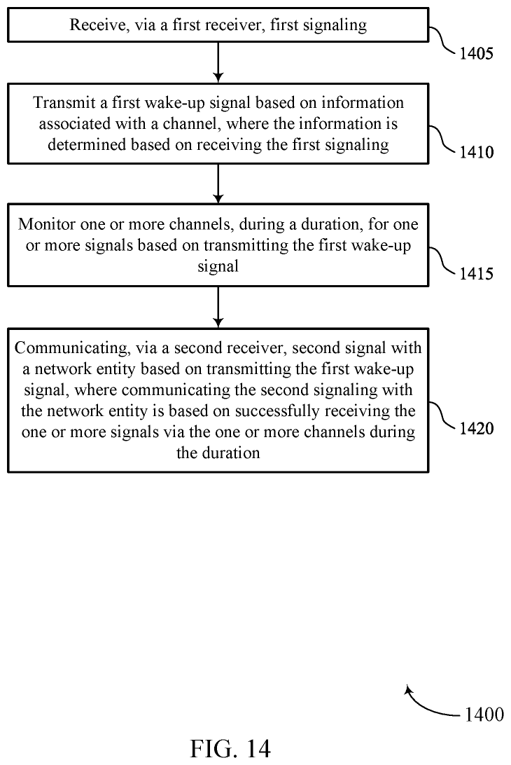

FIG. 14 illustrates a flowchart showing a method 1400 that supports further considerations on C-WUSs in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, via a first receiver, first signaling. The operations of 1405 may be performed in accordance with examples as disclosed herein. In some examples, aspects of the operations of 1405 may be performed by a first signaling component 725 as described with reference to FIG. 7.

At 1410, the method may include transmitting a first WUS based on information associated with a channel, where the information is determined based on receiving the first signaling. The operations of 1410 may be performed in accordance with examples as disclosed herein. In some examples, aspects of the operations of 1410 may be performed by a wake-up signal component 730 as described with reference to FIG. 7.

At 1415, the method may include monitoring one or more channels, during a duration, for one or more signals based on transmitting the first WUS. The operations of 1415 may be performed in accordance with examples as disclosed herein. In some examples, aspects of the operations of 1415 may be performed by a monitoring component 740 as described with reference to FIG. 7.

At 1420, the method may include communicating, via a second receiver, second signaling with a network entity based on transmitting the first WUS, where communicating the second signaling with the network entity is based on successfully receiving the one or more signals via the one or more channels during the duration. The operations of 1420 may be performed in accordance with examples as disclosed herein. In some examples, aspects of the operations of 1420 may be performed by a second signaling component 735 as described with reference to FIG. 7.

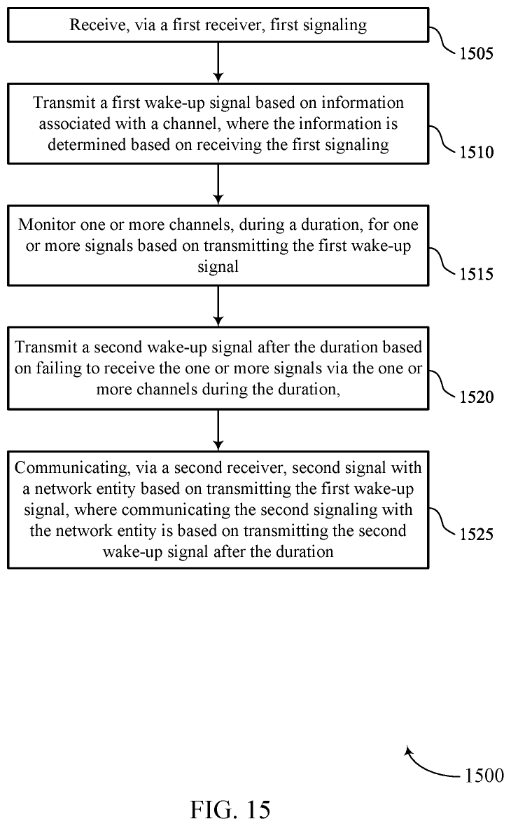

FIG. 15 illustrates a flowchart showing a method 1500 that supports further considerations on C-WUSs in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving, via a first receiver, first signaling. The operations of 1505 may be performed in accordance with examples as disclosed herein. In some examples, aspects of the operations of 1505 may be performed by a first signaling component 725 as described with reference to FIG. 7.

At 1510, the method may include transmitting a first WUS based on information associated with a channel, where the information is determined based on receiving the first signaling. The operations of 1510 may be performed in accordance with examples as disclosed herein. In some examples, aspects of the operations of 1510 may be performed by a wake-up signal component 730 as described with reference to FIG. 7.

At 1515, the method may include monitoring one or more channels, during a duration, for one or more signals based on transmitting the first WUS. The operations of 1515 may be performed in accordance with examples as disclosed herein. In some examples, aspects of the operations of 1515 may be performed by a monitoring component 740 as described with reference to FIG. 7.

At 1520, the method may include transmitting a second WUS after the duration based on failing to receive the one or more signals via the one or more channels during the duration. The operations of 1520 may be performed in accordance with examples as disclosed herein. In some examples, aspects of the operations of 1520 may be performed by a wake-up signal component 730 as described with reference to FIG. 7.

At 1525, the method may include communicating, via a second receiver, second signaling with a network entity based on transmitting the first WUS, where communicating the second signaling with the network entity is based on transmitting the second WUS after the duration. The operations of 1525 may be performed in accordance with examples as disclosed herein. In some examples, aspects of the operations of 1525 may be performed by a second signaling component 735 as described with reference to FIG. 7.

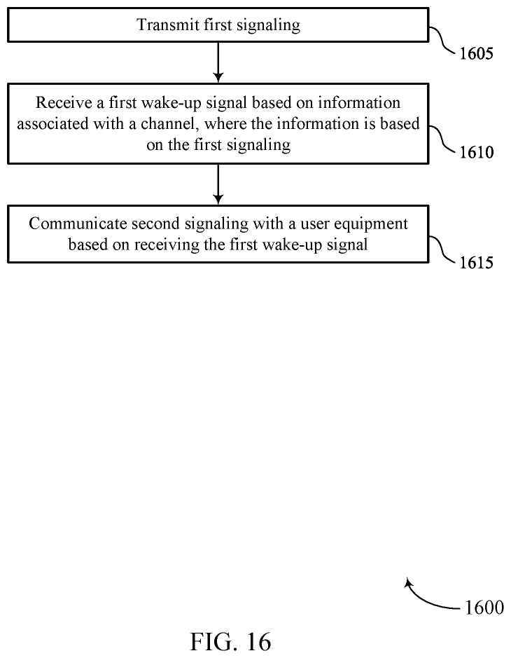

FIG. 16 illustrates a flowchart showing a method 1600 that supports further considerations on C-WUSs in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting first signaling. The operations of 1605 may be performed in accordance with examples as disclosed herein. In some examples, aspects of the operations of 1605 may be performed by a first signaling component 1125 as described with reference to FIG. 11.

At 1610, the method may include receiving a first WUS based on information associated with a channel, where the information is based on the first signaling. The operations of 1610 may be performed in accordance with examples as disclosed herein. In some examples, aspects of the operations of 1610 may be performed by a wake-up signal component 1130 as described with reference to FIG. 11.

At 1615, the method may include communicating second signaling with a user equipment based on receiving the first WUS. The operations of 1615 may be performed in accordance with examples as disclosed herein. In some examples, aspects of the operations of 1615 may be performed by a second signaling component 1135 as described with reference to FIG. 11.

The following provides an overview of aspects of the present disclosure:

Aspect 1: A method for wireless communication, comprising: receiving, via a first receiver, first signaling; transmitting a first wake-up signal based at least in part on information associated with a channel, wherein the information is determined based at least in part on receiving the first signaling; and communicating, via a second receiver, second signaling with a network entity based at least in part on transmitting the first wake-up signal.

Aspect 2: The method of aspect 1, further comprising: monitoring one or more channels, during a duration, for one or more signals based at least in part on transmitting the first wake-up signal, wherein communicating the second signaling with the network entity is based at least in part on successfully receiving the one or more signals via the one or more channels during the duration.

Aspect 3: The method aspect 1, further comprising: monitoring one or more channels, during a duration, for one or more signals based at least in part on transmitting the first wake-up signal; and transmitting a second wake-up signal after the duration based at least in part on failing to receive the one or more signals via the one or more channels during the duration, wherein communicating the second signaling with the network entity is based at least in part on transmitting the second wake-up signal after the duration.

Aspect 4: The method of aspect 3, wherein the duration comprises: a time window, wherein transmitting the second wake-up signal is based at least in part on failing to receive the one or more signals within one or more symbols of the time window; or an expiration of a timer, wherein transmitting the second wake-up signal is based at least in part on failing to receive the one or more signals before the expiration of the timer.

Aspect 5: The method of aspect 4, wherein the time window, the timer, or both, is associated with a first subcarrier spacing, the first subcarrier spacing being associated with the first wake-up signal, the one or more signals, a predefined value, or any combination thereof.

Aspect 6: The method of any of aspects 3 through 5, wherein the second wake-up signal is transmitted based at least in part on the information associated with the channel.

Aspect 7: The method of any of aspects 3 through 5, wherein the second wake-up signal is transmitted based at least in part on second information different from the information.

Aspect 8: The method of any of aspects 3 through 7, wherein the one or more signals comprise at least a synchronization signal block, a signal comprising a system information block, or both, and wherein the one or more channels comprise a physical broadcast channel, a physical downlink shared channel, or both.

Aspect 9: The method of any of aspects 3 through 8, wherein the second wake-up signal comprises a retransmission of the first wake-up signal.

Aspect 10: The method of any of aspects 1 through 9, wherein communicating the second signaling with the network entity based at least in part on transmitting the first wake-up signal comprises: communicating, with the network entity, random access signaling as part of a random access procedure, wherein the random access signaling is communicated based at least in part on the information associated with the channel.

Aspect 11: The method of any of aspects 1 through 10, wherein transmitting the first wake-up signal comprises: transmitting, within the first wake-up signal, channel configuration information associated with a downlink channel based at least in part on performing one or more measurements associated with the downlink channel, the one or more measurements performed based at least in part on receiving third signaling comprising downlink signaling, wherein the method further comprises: receiving one or more reference signals based at least in part on transmitting the channel configuration information.

Aspect 12: The method of aspect 11, wherein transmitting the channel configuration information comprises: selecting a channel configuration based at least in part on performing the one or more measurements associated with the downlink channel; and transmitting an indication of the selected channel configuration.

Aspect 13: The method of any of aspects 11 through 12, wherein the channel configuration information comprises at least one of an antenna port configuration, an updated downlink power, or both, and wherein the downlink channel comprises a physical downlink shared channel.

Aspect 14: The method of any of aspects 11 through 13, wherein the first wake-up signal comprising the channel configuration information is based at least in part on one or more first coding sequences, one or more first preambles, one or more first resource occasions, or any combination thereof, associated with indicating the channel configuration information and different from one or more one or more second coding sequences, one or more second preambles, or one or more second resource occasions associated with a wake-up procedure.

Aspect 15: The method of any of aspects 1 through 14, wherein receiving the first signaling via the first receiver comprises: receiving the first signaling via the first receiver, wherein the first receiver uses a power below a second power associated with the second receiver.

Aspect 16: The method of any of aspects 1 through 15, wherein the information associated with the channel comprises time resource information, frequency resource information, spatial resource information, path loss information, a transmit power, an uplink spatial filter, or any combination thereof, associated with the channel.

Aspect 17: The method of any of aspects 1 through 16, wherein the first signaling comprises a wake-up signal, a synchronization signal, or both.

Aspect 18: A method for wireless communication, comprising: transmitting first signaling; receiving a first wake-up signal based at least in part on information associated with a channel, wherein the information is based at least in part on the first signaling; and communicating second signaling with a user equipment based at least in part on receiving the first wake-up signal.

Aspect 19: The method of aspect 18, further comprising: transmitting one or more signals via one or more channels during a duration, wherein communicating the second signaling with the user equipment is based at least in part on transmitting the one or more signals.

Aspect 20: The method of aspect 18, further comprising: receiving a second wake-up signal after a duration; and transmitting one or more signals via one or more channels based at least in part on receiving the second wake-up signal after the duration, wherein communicating the second signaling with the user equipment is based at least in part on transmitting the one or more signals via the one or more channels.

Aspect 21: The method of aspect 20, wherein the duration comprises a time window or an expiration of a timer, wherein the one or more signals are transmitted after one or more symbols of the time window or after the expiration of the timer.

Aspect 22: The method of aspect 21, wherein the time window, the timer, or both, is associated with a first subcarrier spacing, the first subcarrier spacing being associated with the first wake-up signal, with the one or more signals, with a predefined value, or any combination thereof.

Aspect 23: The method of any of aspects 20 through 22, wherein the second wake-up signal is received based at least in part on the information associated with the channel.

Aspect 24: The method of any of aspects 20 through 22, wherein the second wake-up signal is received based at least in part on second information different from the information.

Aspect 25: The method of any of aspects 20 through 24, wherein the one or more signals comprise at least a synchronization signal block, a signal comprising a system information block, or both, and wherein the one or more channels comprise a physical broadcast channel, a physical downlink shared channel, or both.

Aspect 26: The method of any of aspects 20 through 25, wherein the second wake-up signal comprises a retransmission of the first wake-up signal.

Aspect 27: The method of any of aspects 18 through 26, wherein communicating the second signaling with the user equipment based at least in part on receiving the first wake-up signal comprises: communicating, with the user equipment, random access signaling as part of a random access procedure, wherein the random access signaling is communicated based at least in part on the information associated with the channel.

Aspect 28: The method of any of aspects 18 through 27, wherein receiving the first wake-up signal comprises: receiving, within the first wake-up signal, channel configuration information associated with a downlink channel based at least in part on transmitting third signaling comprising downlink signaling, wherein the method further comprises: transmitting one or more reference signals based at least in part on receiving the channel configuration information.

Aspect 29: The method of aspect 28, wherein receiving the channel configuration information comprises receiving an indication of a selected channel configuration.

Aspect 30: The method of any of aspects 28 through 29, wherein the channel configuration information comprises at least one of an antenna port configuration, a downlink power update, or both, and wherein the downlink channel comprises a physical downlink shared channel.

Aspect 31: The method of any of aspects 28 through 30, wherein the first wake-up signal comprising the channel configuration information is based at least in part on one or more first coding sequences, one or more first preambles, one or more first resource occasions, or any combination thereof, associated with indicating the channel configuration information and different from one or more one or more second coding sequences, one or more second preambles, or one or more second resource occasions associated with a wake-up procedure.

Aspect 32: The method of any of aspects 18 through 31, wherein the information associated with the channel comprises time resource information, frequency resource information, spatial resource information, path loss information, a transmit power, an uplink spatial filter, or any combination thereof, associated with the channel.

Aspect 33: The method of any of aspects 18 through 32, wherein the first signaling comprises a wake-up signal, a synchronization signal, or both.

Aspect 34: An apparatus for wireless communication, comprising a processor; memory coupled with the processor; and instructions stored in the memory and executable by the processor to cause the apparatus to perform a method of any of aspects 1 through 17.

Aspect 35: An apparatus for wireless communication, comprising at least one means for performing a method of any of aspects 1 through 17.

Aspect 36: A non-transitory computer-readable medium storing code for wireless communication, the code comprising instructions executable by a processor to perform a method of any of aspects 1 through 17.

Aspect 37: An apparatus for wireless communication, comprising a processor; memory coupled with the processor; and instructions stored in the memory and executable by the processor to cause the apparatus to perform a method of any of aspects 18 through 33.

Aspect 38: An apparatus for wireless communication, comprising at least one means for performing a method of any of aspects 18 through 33.

Aspect 39: A non-transitory computer-readable medium storing code for wireless communication, the code comprising instructions executable by a processor to perform a method of any of aspects 18 through 33.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication, comprising:
receiving, via a first receiver, first signaling;
transmitting a first wake-up signal based at least in part on information associated with a channel, wherein the information is determined based at least in part on receiving the first signaling; and
communicating, via a second receiver, second signaling with a network entity based at least in part on transmitting the first wake-up signal.

2. The method of claim 1, further comprising:
monitoring one or more channels, during a duration, for one or more signals based at least in part on transmitting the first wake-up signal, wherein communicating the second signaling with the network entity is based at least in part on successfully receiving the one or more signals via the one or more channels during the duration.

3. The method of claim 1, further comprising:
monitoring one or more channels, during a duration, for one or more signals based at least in part on transmitting the first wake-up signal; and
transmitting a second wake-up signal after the duration based at least in part on failing to receive the one or more signals via the one or more channels during the duration, wherein communicating the second signaling with the network entity is based at least in part on transmitting the second wake-up signal after the duration.

4. The method of claim 3, wherein the duration comprises:
a time window, wherein transmitting the second wake-up signal is based at least in part on failing to receive the one or more signals within one or more symbols of the time window; or
an expiration of a timer, wherein transmitting the second wake-up signal is based at least in part on failing to receive the one or more signals before the expiration of the timer.

5. The method of claim 4, wherein the time window, the timer, or both, is associated with a first subcarrier spacing, the first subcarrier spacing being associated with the first wake-up signal, the one or more signals, a predefined value, or any combination thereof.

6. The method of claim 3, wherein the second wake-up signal is transmitted based at least in part on the information associated with the channel.

7. The method of claim 3, wherein the second wake-up signal is transmitted based at least in part on second information different from the information.

8. The method of claim 3, wherein the one or more signals comprise at least a synchronization signal block, a signal comprising a system information block, or both, and wherein the one or more channels comprise a physical broadcast channel, a physical downlink shared channel, or both.

9. The method of claim 3, wherein the second wake-up signal comprises a retransmission of the first wake-up signal.

10. The method of claim 1, wherein communicating the second signaling with the network entity based at least in part on transmitting the first wake-up signal comprises:
communicating, with the network entity, random access signaling as part of a random access procedure, wherein the random access signaling is communicated based at least in part on the information associated with the channel.

11. The method of claim 1, wherein transmitting the first wake-up signal comprises:
transmitting, within the first wake-up signal, channel configuration information associated with a downlink channel based at least in part on performing one or more measurements associated with the downlink channel, the one or more measurements performed based at least in part on receiving third signaling comprising downlink signaling, wherein the method further comprises:
receiving one or more reference signals based at least in part on transmitting the channel configuration information.

12. The method of claim 11, wherein transmitting the channel configuration information comprises:
selecting a channel configuration based at least in part on performing the one or more measurements associated with the downlink channel; and
transmitting an indication of the selected channel configuration.

13. The method of claim 11, wherein the channel configuration information comprises at least one of an antenna port configuration, an updated downlink power, or both, and wherein the downlink channel comprises a physical downlink shared channel.

14. The method of claim 11, wherein the first wake-up signal comprising the channel configuration information is based at least in part on one or more first coding sequences, one or more first preambles, one or more first resource occasions, or any combination thereof, associated with indicating the channel configuration information and different from one or more one or more second coding sequences, one or more second preambles, or one or more second resource occasions associated with a wake-up procedure.

15. The method of claim 1, wherein receiving the first signaling via the first receiver comprises:
receiving the first signaling via the first receiver, wherein the first receiver uses a power below a second power associated with the second receiver.

16. The method of claim 1, wherein the information associated with the channel comprises time resource information, frequency resource information, spatial resource information, path loss information, a transmit power, an uplink spatial filter, or any combination thereof, associated with the channel.

17. The method of claim 1, wherein the first signaling comprises a wake-up signal, a synchronization signal, or both.

18. A method for wireless communication, comprising:
transmitting first signaling;
receiving a first wake-up signal based at least in part on information associated with a channel, wherein the information is based at least in part on the first signaling; and
communicating second signaling with a user equipment based at least in part on receiving the first wake-up signal.

19. The method of claim 18, further comprising:
transmitting one or more signals via one or more channels during a duration, wherein communicating the second signaling with the user equipment is based at least in part on transmitting the one or more signals.

20. The method of claim 18, further comprising:
receiving a second wake-up signal after a duration; and
transmitting one or more signals via one or more channels based at least in part on receiving the second wake-up signal after the duration, wherein communicating the second signaling with the user equipment is based at least in part on transmitting the one or more signals via the one or more channels.

21. The method of claim 20, wherein the duration comprises a time window or an expiration of a timer, wherein the one or more signals are transmitted after one or more symbols of the time window or after the expiration of the timer.

22. The method of claim 21, wherein the time window, the timer, or both, is associated with a first subcarrier spacing, the first subcarrier spacing being associated with the first wake-up signal, with the one or more signals, with a predefined value, or any combination thereof.

23. The method of claim 20, wherein the second wake-up signal is received based at least in part on the information associated with the channel.

24. The method of claim 20, wherein the second wake-up signal is received based at least in part on second information different from the information.

25. The method of claim 20, wherein the one or more signals comprise at least a synchronization signal block, a signal comprising a system information block, or both, and wherein the one or more channels comprise a physical broadcast channel, a physical downlink shared channel, or both.

26. The method of claim 20, wherein the second wake-up signal comprises a retransmission of the first wake-up signal.

27. The method of claim 18, wherein communicating the second signaling with the user equipment based at least in part on receiving the first wake-up signal comprises:
communicating, with the user equipment, random access signaling as part of a random access procedure, wherein the random access signaling is communicated based at least in part on the information associated with the channel.

28. The method of claim 18, wherein receiving the first wake-up signal comprises:
receiving, within the first wake-up signal, channel configuration information associated with a downlink channel based at least in part on transmitting third signaling comprising downlink signaling, wherein the method further comprises:
transmitting one or more reference signals based at least in part on receiving the channel configuration information.

29. An apparatus for wireless communication, comprising:
a processor;
memory coupled with the processor; and
instructions stored in the memory and executable by the processor to cause the apparatus to:
receive, via a first receiver, first signaling;
transmit a first wake-up signal based at least in part on information associated with a channel, wherein the information is determined based at least in part on receiving the first signaling; and
communicating, via a second receiver, second signaling with a network entity based at least in part on transmitting the first wake-up signal.

30. An apparatus for wireless communication, comprising:
a processor;
memory coupled with the processor; and
instructions stored in the memory and executable by the processor to cause the apparatus to:
transmit first signaling;
receive a first wake-up signal based at least in part on information associated with a channel, wherein the information is based at least in part on the first signaling; and
communicate second signaling with a user equipment based at least in part on receiving the first wake-up signal.
